(19) United States
(12) Patent Application Publication
(10) Pub. No.: US 2026/0214004 A1
(43) Pub. Date: Jul. 23, 2026

(54) METHOD AND APPARATUS FOR NETWORK CONFIGURATION

(71) Applicant: Telefonaktiebolaget LM Ericsson (publ), Stockholm (SE)

(72) Inventors: Daiying LIU, Beijing (CN); Xing QIN, Beijing (CN)

(73) Assignee: Telefonaktiebolaget LM Ericsson (publ), Stockholm (SE)

(21) Appl. No.: 19/144,557

(22) PCT Filed: Jan. 20, 2023
(86) PCT No.: PCT/CN2023/073318

§ 371 Date: Jun. 30, 2025

(51) Int. Cl. H04L 41/085; H04L 65/1069

(52) U.S. Cl. CPC H04L 41/085; H04L 65/1069

(57) ABSTRACT

Embodiments of the present disclosure provide method and apparatus for network configuration. A method performed by a configuration node comprises sending a message to a network node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

### TECHNICAL FIELD

The non-limiting and exemplary embodiments of the present disclosure generally relate to the technical field of communications, and specifically to methods and apparatuses for network configuration.

### BACKGROUND

This section introduces aspects that may facilitate a better understanding of the disclosure. Accordingly, the statements of this section are to be read in this light and are not to be understood as admissions about what is in the prior art or what is not in the prior art.

The network configuration may be implemented by various network configuration protocols. For example, Network Configuration Protocol (NETCONF) as defined by Internet Engineering Task Force (IETF), Request for Comments (RFC): 6241 June 2011, the disclosure of which is incorporated by reference herein in its entirety, defines a simple mechanism through which a network device can be managed, configuration data information can be retrieved, and new configuration data can be uploaded and manipulated.

NETCONF provides mechanisms to install, manipulate, and delete the configuration of network devices. NETCONF uses an Extensible Markup Language (XML)-based data encoding for the configuration data as well as the protocol messages. The NETCONF protocol operations are realized as remote procedure calls (RPCs). NETCONF defines the existence of one or more configuration datastores and allows configuration operations on them. Datastore is a conceptual place to store and access information. A datastore might be implemented, for example, using files, a database, flash memory locations, or combinations thereof. A configuration datastore is defined as the complete set of configuration data that is required to get a device from its initial default state into a desired operational state. The configuration datastore does not include state data or executive commands. For example, as described in RFC 6241, the configuration datastore may comprise candidate configuration datastore, running configuration datastore, and startup configuration datastore.

Candidate configuration datastore is a configuration datastore that can be manipulated without impacting the device's current configuration and that can be committed to the running configuration datastore. Not all devices support a candidate configuration datastore.

Running configuration datastore is a configuration datastore holding the complete configuration currently active on the device. The running configuration datastore always exists.

Startup configuration datastore is a configuration datastore holding the configuration loaded by the device when it boots. Only present on devices that separate the startup configuration datastore from the running configuration datastore.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The process for configuring a network node through NETCONF may be as follows.
Step 1: a configuration node such as Network Management System (NMS) may send a configuration to the candidate datastore (DS) of a network node (such as Network Element (NE)) via a NETCONF remote procedure call (RPC).
Step 2: the configuration node may get the data of candidate DS through the “get-config” RPC and a user may carefully check whether the configuration of candidate DS is actually required and whether there is any error. For example, the data obtained from the candidate DS is previous running data (that is the data in current running DS) and the newly configured data set.
Step 3: the configuration node may apply the data of candidate DS to running DS through “copy-config” or “commit” RPC to make it take effect on the node.
Step 4: after confirming that the configured services are running properly, the configuration node may save the data of running DS to startup DS through the “copy-config” RPC to make the configuration take effect after the node is restarted.

From the above process, the applicant found some problems.

General user configurations are performed step by step. After modifying a few configurations and ensuring that the configurations are correct, the user may perform the next configuration. In other words, the user generates multiple commits during configuration.

The user may have difficulty to rollback directly to a previous configuration. The configuration rollback may be required in practice. For example, if the configuration is found to be unreasonable and/or even incorrect, the configuration needs to be rolled back. But in the existing configuration solutions, the rollback is very inconvenient. The user needs to delete a current configuration carefully according to the common configuration steps above to avoid configuration errors (more or less deletion will affect services), which increases the workload of users and is prone to errors.

In additional, it is not uncommon for reconfiguration, like reconfiguration caused by topology changes. The existing configuration solution such as NETCONF-YANG is inconvenient, which increases the workload of users and is prone to errors.

The existing configuration solution such as NETCONF-YANG does not support the direct loading of a DS format configuration (for example, copying a DS configuration directly to the NETCONF session, so that the NE can directly use the configuration), which is inconvenient. For example, in the existing configuration solution, the user needs to manually compare the configuration in the target DS with the currently running configuration to determine the changes in each configuration (XPATH see RFC 6241). Each configuration change needs to specify the path of the change (XPATH). It requires defining modification actions, such as merge, delete, create, etc.

In the existing configuration solution, there is no way to directly load the target configuration to take effect, and the more operations are required. The larger the configuration changes, the greater the workload is, and the higher the probability of error is.

Sometimes, the user may directly “edit-config” running DS if they just change some simple configurations. However this may have some risks, such as the consequences caused by configuration errors.

Sometimes, the user may want to delete or cancel a part of the configurations, not all of the configurations. If the user can only cancel all of the configurations, then the new configuration is still a lot of work and this is useless work. However the existing configuration solution such as NETCONF-YANG does not support a way to delete or cancel a part of the configuration, such as cancel the configuration based on a module.

To overcome or mitigate at least one above mentioned problems or other problems, an improved solution for network configuration may be desirable.

In a first aspect of the disclosure, there is provided a method performed by a configuration node. The method comprises sending a message to a network node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In an embodiment, the method further comprises sending a first request for getting a difference between the running configuration data and second historical running configuration data of the network node to the network node. The method further comprises receiving a first response comprising the difference between the running configuration data and the second historical running configuration data of the network node from the network node.

In an embodiment, the first request comprises a name of the second historical running configuration data.

In an embodiment, the method further comprises sending a second request for getting third historical running configuration data of the network node to the network node. The method further comprises receiving a second response comprising information about the third historical running configuration data of the network node from the network node.

In an embodiment, the second request comprises a name of the third historical running configuration data.

In an embodiment, the information about the third historical running configuration data comprises at least one of the third historical running configuration data, a name of the third historical running configuration data, a timestamp of a running configuration data change, or an identity of a user who triggers the running configuration data change.

In an embodiment, when the message is used for modifying at least one configuration in the running configuration data of the network node based on a module, the message comprises a name of historical running configuration data corresponding to the running configuration data and information indicating the at least one configuration.

In an embodiment, the information indicating the at least one configuration comprises a module name of the at least one configuration.

In an embodiment, when the message is used for rolling back the running configuration data of the network node to the first historical running configuration data of the network node, the message comprises a name of the first historical running configuration data.

In an embodiment, when the message is used for getting a list of historical running configuration data of the network node, the method further comprises receiving the list of historical running configuration data of the network node from the network node.

In an embodiment, the list of historical running configuration data comprises at least one of a name of historical running configuration data, a timestamp of a running configuration data change, or an identity of a user who triggers the running configuration data change.

In an embodiment, the method further comprises receiving information indicating at least one capability of modifying operation, rolling back operation or loading operation from the network node. The message is sent to the network node when the network node supports the at least one capability of modifying operation, rolling back operation or loading operation.

In an embodiment, the information is received from the network node during a session establishment procedure between the configuration node and the network node.

In an embodiment, the information is comprised in a hello message.

In an embodiment, a message exchanged between the configuration node and the network node is encoded in extensible Markup Language (XML).

In an embodiment, a communication between the configuration node and the network node uses at least one of Network Configuration Protocol (NETCONF), RESTCONF protocol, or Simple Network Management Protocol (SNMP).

In an embodiment, the modifying comprises at least one of creating, undoing, or replacing.

In a second aspect of the disclosure, there is provided a method performed by a network node. The method comprises receiving a message from a configuration node. The method further comprises processing the message. The message is used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In an embodiment, the method further comprises receiving a first request for getting a difference between the running configuration data and second historical running configuration data of the network node from the configuration node. The method further comprises comparing the difference between the running configuration data and the second historical running configuration data. The method further comprises sending a first response comprising the difference between the running configuration data and the second historical running configuration data to the configuration node.

In an embodiment, the first request comprises a name of the second historical running configuration data.

In an embodiment, the method further comprises receiving a second request for getting third historical running configuration data of the network node from the configuration node. The method further comprises sending a second response comprising information about the third historical running configuration data of the network node to the configuration node.

In an embodiment, the second request comprises a name of the third historical running configuration data.

In an embodiment, the information about the third historical running configuration data comprises at least one of the third historical running configuration data, a name of the third historical running configuration data, a timestamp of a running configuration data change, or an identity of a user who triggers the running configuration data change.

In an embodiment, when the message is used for modifying at least one configuration in the running configuration data of the network node based on a module, the message comprises a name of historical running configuration data corresponding to the running configuration data and information indicating the at least one configuration and processing the message comprises modifying at least one configuration in the running configuration data based on a module.

In an embodiment, the information indicating the at least one configuration comprises a module name of the at least one configuration.

In an embodiment, modifying at least one configuration in the running configuration data of the network node based on a module comprises checking whether the historical running configuration data corresponding to the running configuration data exists, when the historical running configuration data corresponding to the running configuration data exists, comparing a first difference between the at least one configuration in the historical running configuration data corresponding to the running configuration data and the at least one configuration in the running configuration data, determining a first modifying operation of the at least one configuration based on the first difference, and applying the first modifying operation of the at least one configuration to the running configuration data.

In an embodiment, when the message is used for rolling back the running configuration data of the network node to the first historical running configuration data of the network node, the message comprises a name of the first historical running configuration data and processing the message comprises rolling back the running configuration data of the network node to the first historical running configuration data of the network node.

In an embodiment, rolling back the running configuration data of the network node to the first historical running configuration data of the network node comprises checking whether the first historical running configuration data exists, when the first historical running configuration data exists, comparing a second difference between the running configuration data and the first historical running configuration data, determining a second modifying operation based on the second difference and applying the second modifying operation to the running configuration data.

In an embodiment, when the message is used for loading datastore format configuration data in the message to the running configuration data of the network node, processing the message comprises loading the datastore format configuration data in the message to the running configuration data of the network node.

In an embodiment, loading datastore format configuration data in the message to the running configuration data of the network node comprises comparing a third difference between the running configuration data and the datastore format configuration data in the message, determining a third modifying operation based on the third difference, and applying the third modifying operation to the running configuration data.

In an embodiment, when the message is used for getting a list of historical running configuration data of the network node, the method further comprises sending the list of historical running configuration data of the network node to the configuration node.

In an embodiment, the list of historical running configuration data comprises at least one of a name of historical running configuration data, a timestamp of a running configuration data change, or an identity of a user who triggers the running configuration data change.

In an embodiment, the method further comprises sending information indicating at least one capability of modifying operation, rolling back operation or loading operation to the configuration node. The message is received from the configuration node when the network node supports the at least one capability of modifying operation, rolling back operation or loading operation.

In an embodiment, the information is sent to the configuration node during a session establishment procedure between the configuration node and the network node.

In an embodiment, the information is comprised in a hello message.

In an embodiment, the method further comprises generating information about historical running configuration data. The method further comprises storing the information about the historical running configuration data.

In an embodiment, the information about the historical running configuration data comprises at least one of the historical running configuration data, a name of the historical running configuration data, a timestamp of a running configuration data change, or an identity of a user who triggers the running configuration data change.

In an embodiment, a message exchanged between the configuration node and the network node is encoded in extensible Markup Language (XML).

In an embodiment, a communication between the configuration node and the network node uses at least one of Network Configuration Protocol (NETCONF), RESTCONF protocol, or Simple Network Management Protocol (SNMP).

In an embodiment, the modifying comprises at least one of creating, undoing, or replacing.

In a third aspect of the disclosure, there is provided a configuration node. The configuration node comprises a processor and a memory coupled to the processor. Said memory contains instructions executable by said processor. Said configuration node is operative to send a message to a network node. The message is used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In a fourth aspect of the disclosure, there is provided a network node. The network node comprises a processor and a memory coupled to the processor. Said memory contains instructions executable by said processor. Said network node is operative to receive a message from a configuration node. Said network node is further operative to process the message. The message is used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In a fifth aspect of the disclosure, there is provided a configuration node. The configuration node comprises a first sending module configured to send a message to a network node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In an embodiment, the configuration node further comprises a second sending module configured to send a first request for getting a difference between the running configuration data and second historical running configuration data of the network node to the network node.

In an embodiment, the configuration node further comprises a first receiving module configured to receive a first response comprising the difference between the running configuration data and the second historical running configuration data of the network node from the network node.

In an embodiment, the configuration node further comprises a third sending module configured to send a second request for getting third historical running configuration data of the network node to the network node.

In an embodiment, the configuration node further comprises a second receiving module configured to receive a second response comprising information about the third historical running configuration data of the network node from the network node.

In an embodiment, the configuration node further comprises a third receiving module configured to receive the list of historical running configuration data of the network node from the network node.

In an embodiment, the configuration node further comprises a fourth receiving module configured to receive information indicating at least one capability of modifying operation, rolling back operation or loading operation from the network node. The message may be sent to the network node when the network node supports the at least one capability of modifying operation, rolling back operation or loading operation.

In a sixth aspect of the disclosure, there is provided a network node. The network node comprises a first receiving module configured to receive a message from a configuration node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node. The network node further comprises a processing module configured to process the message.

In an embodiment, the network node further comprises a second receiving module configured to receive a first request for getting a difference between the running configuration data and second historical running configuration data of the network node from the configuration node.

In an embodiment, the network node further comprises a first comparing module configured to compare the difference between the running configuration data and the second historical running configuration data.

In an embodiment, the network node further comprises a first sending module configured to send a first response comprising the difference between the running configuration data and the second historical running configuration data to the configuration node.

In an embodiment, the network node further comprises a third receiving module configured to receive a second request for getting third historical running configuration data of the network node from the configuration node.

In an embodiment, the network node further comprises a second sending module configured to send a second response comprising information about the third historical running configuration data of the network node to the configuration node.

In an embodiment, the network node further comprises a third sending module configured to send the list of historical running configuration data of the network node to the configuration node.

In an embodiment, the network node further comprises a fourth sending module configured to send information indicating at least one capability of modifying operation, rolling back operation or loading operation to the configuration node. The message may be received from the configuration node when the network node supports the at least one capability of modifying operation, rolling back operation or loading operation.

In an embodiment, the network node further comprises a generating module configured to generate information about historical running configuration data.

In an embodiment, the network node further comprises a storing module configured to store the information about the historical running configuration data.

In a seventh aspect of the disclosure, there is provided a computer program product comprising instructions which, when executed on at least one processor, cause the at least one processor to carry out any of the methods according to the first and second aspects of the disclosure.

In an eighth aspect of the disclosure, there is provided a computer-readable storage medium storing instructions which, when executed on at least one processor, cause the at least one processor to carry out any of the methods according to the first and second aspects of the disclosure.

Embodiments herein afford many advantages, of which a non-exhaustive list of examples follows. In some embodiments herein, the proposed solution can enable the configuration process (such as NETCONF-YANG configuration process) to be more convenient. In some embodiments herein, the proposed solution can reduce the workload of users and/or configuration errors. In some embodiments herein, the proposed solution can provide a convenient way to record and/or view and/or roll back historical configuration (such as NETCONF-YANG's historical configuration) for the benefit of users. In some embodiments herein, the proposed solution can undo historical configuration in module unit. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of NETCONF Protocol Layers according to an embodiment of the present disclosure;

FIG. 2 shows a model of datastore as it is currently used by NETCONF according to an embodiment of the present disclosure;

FIG. 3 shows a new model of datastore according to an embodiment of the present disclosure;

FIG. 4 shows a flowchart of a method according to an embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14a shows a flowchart of a method according to another embodiment of the present disclosure;

FIG. 14b shows a flowchart of a method according to another embodiment of the present disclosure;

FIG. 15a shows a flowchart of a method according to another embodiment of the present disclosure;

FIG. 15b shows a flowchart of a method according to another embodiment of the present disclosure;

FIG. 16 shows a flowchart of storing running DS change image according to another embodiment of the present disclosure;

FIG. 17 shows a flowchart of getting stored running DS image according to another embodiment of the present disclosure;

FIG. 18 shows a flowchart of getting a difference between stored running DS image and current running DS according to another embodiment of the present disclosure;

FIG. 19 shows a flowchart of unconfiguring a module of configuration, which was configured in the history and stored in LIST config-record-entry, in the current running DS according to another embodiment of the present disclosure;

FIG. 20 shows a flowchart of rolling back a configuration of the running DS to the configuration of a node stored in LIST config-record-entry according to another embodiment of the present disclosure;

FIG. 21 shows a flowchart of restoring configuration of the running DS according to another embodiment of the present disclosure;

FIG. 22 is a block diagram showing an apparatus suitable for practicing some embodiments of the disclosure; and

FIG. 23 is a block diagram showing a configuration node according to an embodiment of the disclosure;

FIG. 24 is a block diagram showing a network node according to an embodiment of the disclosure;

FIG. 25 shows an example of a communication system according to an embodiment of the disclosure;

FIG. 26 is a block diagram of a host according to an embodiment of the disclosure; and

FIG. 27 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3rd Generation Partnership Project (3GPP). For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure.

The network function (NF) can be implemented in a network element (physical or virtual) of a communication network. For example, the network node can be implemented either as a network element on a dedicated hardware, as a software instance running on a dedicated hardware, or as a virtualized function instantiated on an appropriate platform, e.g. on a cloud infrastructure.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media—having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the Network Configuration Protocol (NETCONF) as defined by IETF RFC 6241 and Network Management Datastore Architecture (NMDA) as defined by IETF RFC 8342 being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other network configuration/management technologies may equally be utilized as long as exemplary embodiments described herein are applicable.

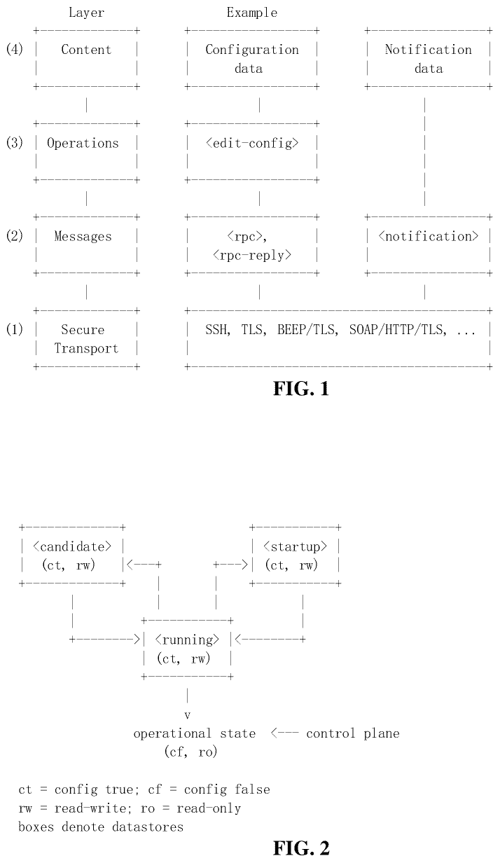

FIG. 1 shows an example of NETCONF Protocol Layers according to an embodiment of the present disclosure, which is same as FIG. 1 of IETF RFC 6241.

NETCONF uses a simple RPC-based mechanism to facilitate communication between a client and a server. The client can be a script or application typically running as part of a network manager. The server is typically a network device. The terms “device” and “server” are used interchangeably in this document, as are “client” and “application”. A NETCONF session is the logical connection between a network administrator or network configuration application and a network device. A device may support at least one NETCONF session and may support multiple sessions. Global configuration attributes can be changed during any authorized session, and the effects are visible in all sessions. Session-specific attributes affect only the session in which they are changed.

NETCONF can be conceptually partitioned into four layers as shown in FIG. 1.

The fourth layer is Secure Transport layer. The Secure Transport layer provides a communication path between the client and server. NETCONF can be layered over any transport protocol that provides a set of basic requirements. For example, the transport protocol may comprise SSH (Secure Shell), TLS (Transport Layer Security), BEEP (Blocks Extensible Exchange Protocol)/TLS, SOAP (Simple Object Access Protocol)/HTTP (Hypertext Transfer Protocol)/TLS, etc.

The third layer is Messages layer. The Messages layer provides a simple, transport-independent framing mechanism for encoding RPCs and notifications.

The second layer is Operations layer. The Operations layer defines a set of base protocol operations invoked as RPC methods with XML-encoded parameters.

The first layer is content layer. An example of the content layer may comprise configuration data or notification data.

The YANG data modeling language as defined by IETF RFC 6020 has been developed for specifying NETCONF data models and protocol operations, covering the Operations and the Content layers of FIG. 1.

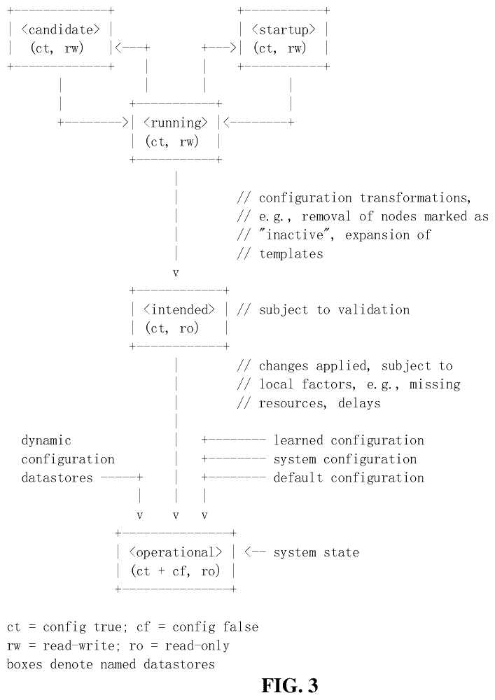

FIG. 2 shows a model of datastore as it is currently used by NETCONF according to an embodiment of the present disclosure. FIG. 2 is same as FIG. 1 of IETF RFC 8342, Network Management Datastore Architecture, Jan. 13, 2018, the disclosure of which is incorporated by reference herein in its entirety.

Note that this diagram simplifies the model: read-only (ro) and read-write (rw) is to be understood at a conceptual level. In NETCONF, for example, support for <candidate> and <startup> is optional and <running> does not have to be writable. Furthermore, <startup> can only be modified by copying <running> to <startup> in the standardized NETCONF datastore editing model. The RESTCONF protocol does not expose these differences and instead provides only a writable unified datastore, which hides whether edits are done through <candidate> or by directly modifying <running> or via some other implementation specific mechanism. RESTCONF also hides how configuration is made persistent. Note that implementations may also have additional datastores that can propagate changes to <running>. NETCONF explicitly mentions so called named datastores.

RESTCONF is defined by Bierman, A., Bjorklund, M., and K. Watsen, “RESTCONF Protocol”, RFC 8040, DOI 10.17487/RFC8040, January 2017, <https://www.rfc-editor.org/info/rfc8040>.

FIG. 3 shows a new model of datastore according to an embodiment of the present disclosure. FIG. 3 is same as FIG. 2 of IETF RFC 8342.

The conventional configuration datastores are a set of configuration datastores that share exactly the same datastore schema, allowing data to be copied between them. The term is meant as a generic umbrella description of these datastores. If a module does not contain any configuration data nodes and it is not needed to satisfy any imports, then it MAY be omitted from the datastore schema for the conventional configuration datastores. The set of datastores include: <running>, <candidate>, <startup>, and <intended>.

The startup configuration datastore (<startup>) is a configuration datastore holding the configuration loaded by the device when it boots. <startup> is only present on devices that separate the startup configuration from the running configuration datastore. The startup configuration datastore may not be supported by all protocols or implementations. On devices that support non-volatile storage, the contents of <startup> will typically persist across reboots via that storage. At boot time, the device loads the saved startup configuration into <running>. To save a new startup configuration, data is copied to <startup>, either via implicit or explicit protocol operations.

The candidate configuration datastore (<candidate>) is a configuration datastore that can be manipulated without impacting the device's current configuration and that can be committed to <running>. The candidate configuration datastore may not be supported by all protocols or implementations. <candidate> does not typically persist across reboots, even in the presence of non-volatile storage. If <candidate> is stored using non-volatile storage, it is reset at boot time to the contents of <running>.

The running configuration datastore (<running>) is a configuration datastore that holds the current configuration of the device. It may include configuration that requires further transformation before it can be applied, e.g., inactive configuration, or template-mechanism-oriented configuration that needs further expansion. However, <running> must always be a valid configuration data tree. <running> MUST be supported if the device can be configured via conventional configuration datastores. If a device does not have a distinct <startup> and non-volatile storage is available, the device will typically use that non-volatile storage to allow <running> to persist across reboots.

The intended configuration datastore (<intended>) is a read-only configuration datastore. It represents the configuration after all configuration transformations to <running> are performed (e.g., template expansion, removal of inactive configuration), and is the configuration that the system attempts to apply. <intended> is tightly coupled to <running>. Whenever data is written to <running>, then <intended> must also be immediately updated by performing all necessary configuration transformations to the contents of <running> and then <intended> is validated. <intended> may also be updated independently of <running> if the effect of a configuration transformation changes, but <intended> must always be a valid configuration data tree. For simple implementations, <running> and <intended> are identical.

The datastore schema for a dynamic configuration datastore may differ from the datastore schema used for conventional configuration datastores. If a module does not contain any configuration data nodes and it is not needed to satisfy any imports, then it may be omitted from the datastore schema for the dynamic configuration datastore.

An example of current running configuration may be as following.

```
<interfaces xmlns=“urn:ietf:params:xml:ns:yang:ietf-interfaces”>
  <interface>
    <name>mgmt@local</name>
    <type xmlns:ianaift=“urn:ietf:params:xml:ns:yang:iana-if-type”>ianaift:ipForward</type>
    <l3-interface xmlns=“urn:rdns:com:ericsson:oammodel:ericsson-interfaces-ext-router6000”>
      <context>local</context>
      <ip>
        <address>
          <addr-primary-conf>
            <addr>10.170.115.176/24</addr>
          </addr-primary-conf>
        </address>
      </ip>
    </l3-interface>
  </interface>
  <interface>
    <name>1/7</name>
    <type xmlns:ianaift=“urn:ietf:params:xml:ns:yang:iana-if-type”>ianaift:ethernetCsmacd</type>
    <enabled>true</enabled>
    <ethernet xmlns=“urn:rdns:com:ericsson:oammodel:ericsson-ethernet-ext-router6000”>
      <port-type>10ge</port-type>
    </ethernet>
  </interface>
  <interface>
    <name>management</name>
    <type xmlns:ianaift=“urn:ietf:params:xml:ns:yang:iana-if-type”>ianaift:ethernetCsmacd</type>
    <enabled>true</enabled>
    <ethernet xmlns=“urn:rdns:com:ericsson:oammodel:ericsson-ethernet-ext-router6000”>
      <bind-interface>
        <intf-name>mgmt@local</intf-name>
        <intf-ctx>local</intf-ctx>
      </bind-interface>
    </ethernet>
  </interface>
</interfaces>
```

An example of target DS format configuration may be as following. Comparing to current running configuration, the underlined part is added.

```
<interfaces xmlns=“urn:ietf:params:xml:ns:yang:ietf-interfaces”>
  <interface>
    <name>mgmt@local</name>
    <type xmlns:ianaift=“urn:ietf:params:xml:ns:yang:iana-if-type”>ianaift:ipForward</type>
    <l3-interface
xmlns=“urn:rdns:com:ericsson:oammodel:ericsson-interfaces-ext-router6000”>
      <context>local</context>
      <ip>
        <address>
          <addr-primary-conf>
            <addr>10.170.115.176/24</addr>
          </addr-primary-conf>
        </address>
      </ip>
    </l3-interface>
  </interface>
  <interface>
    <name>1/4</name>
    <type
xmlns:ianaift=“urn:ietf:params:xml:ns:yang:iana-if-type”>ianaift:ethernetCsmacd</type>
    <enabled>false</enabled>
    <ethernet
    xmlns=“urn:rdns:com:ericsson:oammodel:ericsson-ethernet-ext-router6000”>
      <port-type>1ge</port-type>
    </ethernet>
  </interface>
  <interface>
    <name>1/7</name>
    <type
xmlns:ianaift=“urn:ietf:params:xml:ns:yang:iana-if-type”>ianaift:ethernetCsmacd</type>
    <enabled>true</enabled>
    <ethernet xmlns=“urn:rdns:com:ericsson:oammodel:ericsson-ethernet-ext-router6000”>
      <port-type>10ge</port-type>
    </ethernet>
  </interface>
  <interface>
    <name>management</name>
    <type
xmlns:ianaift=“urn:ietf:params:xml:ns:yang:iana-if-type”>ianaift:ethernetCsmacd</type>
    <enabled>true</enabled>
    <ethernet xmlns=“urn:rdns:com:ericsson:oammodel:ericsson-ethernet-ext-router6000”>
      <bind-interface>
        <intf-name>mgmt@local</intf-name>
        <intf-ctx>local</intf-ctx>
      </bind-interface>
    </ethernet>
  </interface>
</interfaces>
```

At present, there is no way to directly load the target DS format configuration to take effect, and the following operations are required. The larger the configuration changes, the greater the workload is, and the higher the probability of error is.

```
<?xml version=‘1.0’ encoding=‘UTF-8’?>
<rpc xmlns:xc=“urn:ietf:params:xml:ns:netconf:base:1.0”
      message-id=“urn:uuid:dd92b8d9-207e-11e5-814f-fc15b40d1048”
      xmlns=“urn:ietf:params:xml:ns:netconf:base:1.0”>
  <edit-config>
  <target>
    <running/>
  </target>
  <default-operation>none</default-operation>
  <config>
    <interfaces xmlns=“urn:ietf:params:xml:ns:yang:ietf-interfaces”>
        <interface xc:operation=“delete”>
          <name>1/4</name>
          <type
xmlns:ianaift=“urn:ietf:params:xml:ns:yang:iana-if-type”>ianaift:ethernetCsmacd</type>
        </interface>
    </interfaces>
  </config>
  </edit-config>
</rpc>
]]>]]>
```

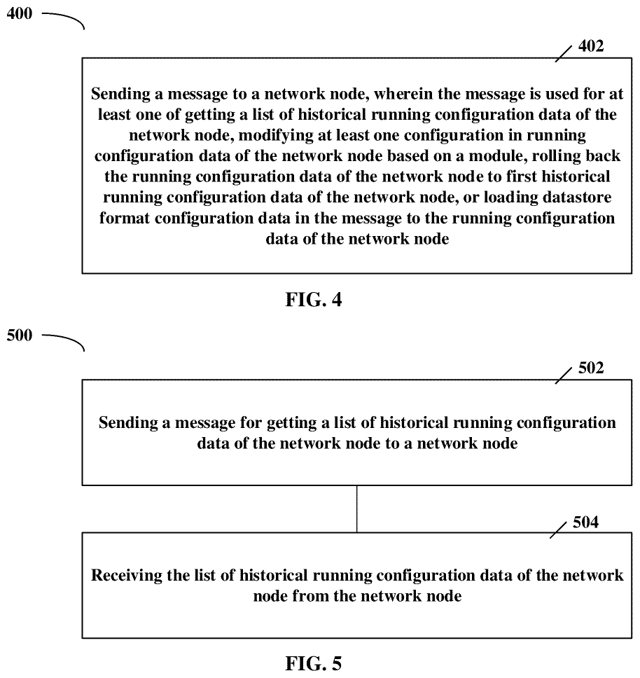

FIG. 4 shows a flowchart of a method according to an embodiment of the present disclosure, which may be performed by an apparatus implemented in or at or as a configuration node or communicatively coupled to the configuration node. As such, the apparatus may provide means or modules for accomplishing various parts of the method 400 as well as means or modules for accomplishing other processes in conjunction with other components.

The configuration node may be any suitable device, entity or function which can be implemented in a physical entity or virtual function. For example, the configuration node may be implemented as one or more applications (which may alternatively be called software instances, virtual appliances, network functions, virtual nodes, virtual network functions, etc.) operative to implement some of the features, functions, and/or benefits of some of the embodiments disclosed herein. In an embodiment, the configuration node may be a network management node such as NMS. In an embodiment where NETCONF protocol is used, the configuration node may be or comprise a client which can invoke protocol operations of NETCONF protocol on a server (e.g., a network node).

At block 402, the configuration node may send a message to a network node.

In an embodiment, the message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

The datastore format may be same or similar as/to the corresponding datastore format as described in IETF RFC 6241 or IETF RFC 8342.

In an embodiment, the message may be used for getting a difference between the running configuration data and second historical running configuration data of the network node to the network node.

In an embodiment, the message may be used for getting third historical running configuration data of the network node to the network node.

The messages for different purposes may be sent multiple times. For example, the configuration node may send a message for getting a list of historical running configuration data of the network node. Then the configuration node may send a message for modifying at least one configuration in running configuration data of the network node based on a module, or modifying at least one configuration in running configuration data of the network node based on a module, or getting a difference between the running configuration data and second historical running configuration data of the network node, or getting third historical running configuration data of the network node.

The network node may be any suitable device, entity or function which can be implemented in a physical entity or virtual function. For example, the network node may be implemented as one or more applications (which may alternatively be called software instances, virtual appliances, network functions, virtual nodes, virtual network functions, etc.) operative to implement some of the features, functions, and/or benefits of some of the embodiments disclosed herein. In an embodiment where NETCONF protocol is used, the network node may be or comprise a server which can executes protocol operations of NETCONF protocol invoked by a client.

In an embodiment, the network node may be a core network node or access network node of a communication network as defined 3rd Generation Partnership Project (3GPP). For example, the 5G system (5GS) may comprise a plurality of network functions (NFs) such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc.

The network node may be an access network device with accessing function in a communication network via which a terminal device accesses to the network and receives services therefrom. The access network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The message may be any suitable message. For example, the message may be a message of a network configuration/management protocol. In an embodiment, the network configuration/management protocol may comprise at least one of RESTCONF protocol, NETCONF protocol, or SNMP (Simple Network Management Protocol), etc.

The configuration data may comprise any suitable data related to configuration of the network node. For example, the configuration data may comprise configuration data related to a protocol executed by the network node. The configuration data may comprise configuration data related to a function of the network node. The configuration data may comprise configuration data related to an algorithm executed by the network node.

In an embodiment, the running configuration data may be same or similar as/to the corresponding running configuration datastore as described in RFC 8342.

In an embodiment, the message may be used for getting a list of historical running configuration data of the network node.

The list of historical running configuration data may comprise any suitable information related to historical running configuration data.

In an embodiment, the list of historical running configuration data may comprise at least one of a name of historical running configuration data, a timestamp of a running configuration data change, or an identity of a user who triggers the running configuration data change.

The name of historical running configuration data may be any suitable information which can be used to identify the historical running configuration data and the present disclosure has no limit on it.

The timestamp of a running configuration data change may be a date and time for example expressed in the format described in IETF RFC 3339, Date and Time on the Internet: Timestamps.

The identity of a user may be any suitable information which can be used to identify the user and the present disclosure has no limit on it.

The historical running configuration data may be generated in various ways and the present disclosure has no limit on it. For example, after the running configuration data is changed, the network node may generate historical running configuration data from the current running configuration data, generate a name of the historical running configuration data, and record a timestamp of a running configuration data change and an identity of a user who triggers the running configuration data change.

In an embodiment, the list of historical running configuration data of the network node may be obtained by the configuration node in another way. For example, the network node may send the list of historical running configuration data of the network node to the configuration node for example during a session establishment procedure between the configuration node and the network node. The configuration node may obtain the list of historical running configuration data of the network node from another network node.

In an embodiment, the message may be used for modifying at least one configuration in running configuration data of the network node based on a module. The at least one configuration may be any suitable configuration (such as configuration of a module or a unit or a circuit or a function or an interface, etc.) and the present disclosure has no limit on it. In an embodiment, the modifying unit may be a module. For example, if the configuration node wants to modify a module of the running configuration data, the message may comprise information indicating the module. If the configuration node wants to modify two modules of the running configuration data, the message may comprise information indicating the two modules.

In an embodiment, when the message is used for modifying at least one configuration in the running configuration data of the network node based on a module, the message may comprise a name of historical running configuration data corresponding to the running configuration data and information indicating the at least one configuration.

The information indicating the at least one configuration may be any suitable information. In an embodiment, the information indicating the at least one configuration may comprise a module name of the at least one configuration.

In an embodiment, the modifying may comprise at least one of creating, undoing (or deleting or cancelling), or replacing.

In an embodiment, the message may be used for rolling back the running configuration data of the network node to first historical running configuration data of the network node.

In an embodiment, when the message is used for rolling back the running configuration data of the network node to the first historical running configuration data of the network node, the message may comprise a name of the first historical running configuration data.

The message may be sent to the network node due to various reasons and the present disclosure has no limit on it. For example, when a user wants to get a list of historical running configuration data of the network node, the message may be sent to the network node. When a user wants to modify at least one configuration in running configuration data of the network node based on a module, the message may be sent to the network node. When a user wants to roll back the running configuration data of the network node to first historical running configuration data of the network node, the message may be sent to the network node. When a user wants to load datastore format configuration data in the message to the running configuration data of the network node, the message may be sent to the network node.

FIG. 5 shows a flowchart of a method according to another embodiment of the present disclosure, which may be performed by an apparatus implemented in or at or as a configuration node or communicatively coupled to the configuration node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the configuration node may send a message for getting a list of historical running configuration data of the network node to a network node.

At block 504, the configuration node may receive the list of historical running configuration data of the network node from the network node.

In an embodiment, the configuration node may provide the list of historical running configuration data of the network node to a user. The configuration node may provide the list of historical running configuration data of the network node to the user in various ways such as audio, video, image, text, etc.

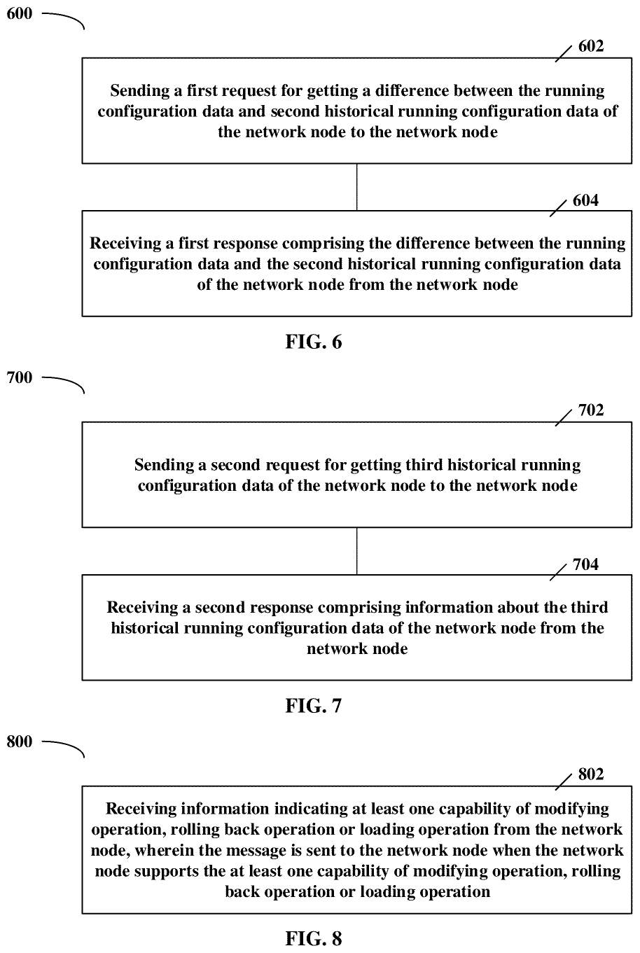

FIG. 6 shows a flowchart of a method according to another embodiment of the present disclosure, which may be performed by an apparatus implemented in or at or as a configuration node or communicatively coupled to the configuration node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the configuration node may send a first request for getting a difference between the running configuration data and second historical running configuration data of the network node to the network node.

The first request may be sent to the network node due to various reasons and the present disclosure has no limit on it. For example, After a user has modified the running configuration data, the first request may be sent to the network node for example immediately. Before a user modifies the running configuration data, the first request may be sent to the network node. When a user wants to perform troubleshooting or maintenance or routine work, the first request may be sent to the network node.

The first request may be any suitable request. For example, the first request may be a request of a network configuration/management protocol. For example, the network configuration/management protocol may comprise at least one of RESTCONF protocol, NETCONF protocol, or SNMP, etc.

In an embodiment, the first request may comprise a name of the second historical running configuration data.

At block 604, the configuration node may receive a first response comprising the difference between the running configuration data and the second historical running configuration data of the network node from the network node.

The first response may be any suitable request. For example, the first response may be a response of a network configuration/management protocol. For example, the network configuration/management protocol may comprise at least one of RESTCONF protocol, NETCONF protocol, or SNMP, etc.

In an embodiment, the first response may be a positive response. For example, if the network node can satisfy the first request, the network node such as server or NE can send the first response (e.g., a RPC-reply element) containing a data element with the difference of between the running configuration data and the second historical running configuration data to the configuration node.

In other embodiments, the first response may be a negative response. For example, if the first request cannot be completed for any reason, for example, the network node cannot satisfy the first request or the network node does not support the function of difference comparation of configuration data or the second historical running configuration data can't be found, the network node such as server or NE can send the first response (e.g., the RPC-reply element) containing a RPC-error element to the configuration node.

The first request and the first response may take any suitable message form and the present disclosure has no limit on it. For example an Extensible Markup Language (XML)-based data encoding may be used for the configuration data as well as the first request and the first response.

In an embodiment, the configuration node may provide the difference between the running configuration data and the second historical running configuration data to a user. The configuration node may provide the difference between the running configuration data and the second historical running configuration data to the user in various ways such as audio, video, image, text, etc.

FIG. 7 shows a flowchart of a method according to another embodiment of the present disclosure, which may be performed by an apparatus implemented in or at or as a configuration node or communicatively coupled to the configuration node. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the configuration node may send a second request for getting third historical running configuration data of the network node to the network node.

The second request may be sent to the network node due to various reasons and the present disclosure has no limit on it. For example, After a user has modified the running configuration data, the second request may be sent to the network node for example immediately. Before a user modifies the running configuration data, the second request may be sent to the network node. When a user wants to perform troubleshooting or maintenance or routine work, the second request may be sent to the network node.

The second request may be any suitable request. For example, the second request may be a request of a network configuration/management protocol. For example, the network configuration/management protocol may comprise at least one of RESTCONF protocol, NETCONF protocol, or SNMP, etc.

In an embodiment, the second request may comprise a name of the third historical running configuration data.

At block 704, the configuration node may receive a second response comprising information about the third historical running configuration data of the network node from the network node.

The second response may be any suitable response. For example, the second response may be a response of a network configuration/management protocol. For example, the network configuration/management protocol may comprise at least one of RESTCONF protocol, NETCONF protocol, or SNMP, etc.

In an embodiment, the second response may be a positive response. For example, if the network node can satisfy the second request, the network node such as server or NE can send the second response (e.g., a RPC-reply element) containing a data element with the information about the third historical running configuration data of the network node to the configuration node.

In other embodiments, the second response may be a negative response. For example, if the second request cannot be completed for any reason, for example, the network node cannot satisfy the second request or the network node does not support the function related to historical running configuration data or the third historical running configuration data can't be found, the network node such as server or NE can send the second response (e.g., the RPC-reply element) containing a RPC-error element to the configuration node.

The second request and the second response may take any suitable message form and the present disclosure has no limit on it. For example an Extensible Markup Language (XML)-based data encoding may be used for the configuration data as well as the second request and the second response.

The information about the third historical running configuration data may comprise any suitable information related to the third historical running configuration data. In an embodiment, the information about the third historical running configuration data may comprise at least one of the third historical running configuration data, a name of the third historical running configuration data, a timestamp of a running configuration data change, or an identity of a user who triggers the running configuration data change.

In an embodiment, the configuration node may provide information about the third historical running configuration data to a user. The configuration node may provide information about the third historical running configuration data to the user in various ways such as audio, video, image, text, etc.

FIG. 8 shows a flowchart of a method according to another embodiment of the present disclosure, which may be performed by an apparatus implemented in or at or as a configuration node or communicatively coupled to the configuration node. As such, the apparatus may provide means or modules for accomplishing various parts of the method 800 as well as means or modules for accomplishing other processes in conjunction with other components. For some parts which have been described in the above embodiments, the description thereof is omitted here for brevity.

At block 802, the configuration node may receive information indicating at least one capability of modifying operation, rolling back operation or loading operation from the network node.

The information may take any suitable form such as bit, flag, indication, identifier, etc.

The information may be comprised in any suitable message such as existing or new message and the present disclosure has no limit on it.

In an embodiment, the information is received from the network node during a session establishment procedure between the configuration node and the network node. For example, a secure connection-oriented session may be established between the configuration node and the network node to exchange messages.

In an embodiment, the information is comprised in a hello message. For example, capabilities may be advertised in messages sent by each peer during session establishment. When a session (such as NETCONF session) is opened, each peer (both the configuration node and the network node) can send a hello message containing a list of that peer's capabilities. The network node may send this information in the hello message when it supports at least one capability of modifying operation, rolling back operation or loading operation from the network node.

In an embodiment, the message is sent to the network node when the network node supports the at least one capability of modifying operation, rolling back operation or loading operation.

In an embodiment, a message exchanged between the configuration node and the network node may be encoded in extensible Markup Language (XML). For example, the message, the first request, the first response, the second request, the second response, the information may be encoded in XML. In other embodiments, the message exchanged between the configuration node and the network node may be encoded in any other suitable language.

In an embodiment, a communication between the configuration node and the network node uses at least one of Network Configuration Protocol (NETCONF), RESTCONF protocol, or Simple Network Management Protocol (SNMP).

FIG. 9 shows a flowchart of a method according to another embodiment of the present disclosure, which may be performed by an apparatus implemented in or at or as a network node or communicatively coupled to the network node. As such, the apparatus may provide means or modules for accomplishing various parts of the method 900 as well as means or modules for accomplishing other processes in conjunction with other components. For some parts which have been described in the above embodiments, the description thereof is omitted here for brevity.

At block 902, the network node may generate information about historical running configuration data.

The information about the historical running configuration data may comprise any suitable information about the historical running configuration data. In an embodiment, the information about the historical running configuration data may comprise at least one of the historical running configuration data, a name of the historical running configuration data, a timestamp of a running configuration data change, or an identity of a user who triggers the running configuration data change.

The network node may generate information about historical running configuration data in various ways. For example, the network node may automatically generate information about the historical running configuration data every time the running configuration data changes. For example, the network node may assign a human readable name for the historical running configuration data. The network node may record the time when the configuration change occurred. The network node may record the user who modified the configuration. The network node may save the running configuration data as the historical running configuration data.

At block 904, the network node may store the information about the historical running configuration data. For example, the configuration node may store the information about the historical running configuration data in historical running configuration data datastore.

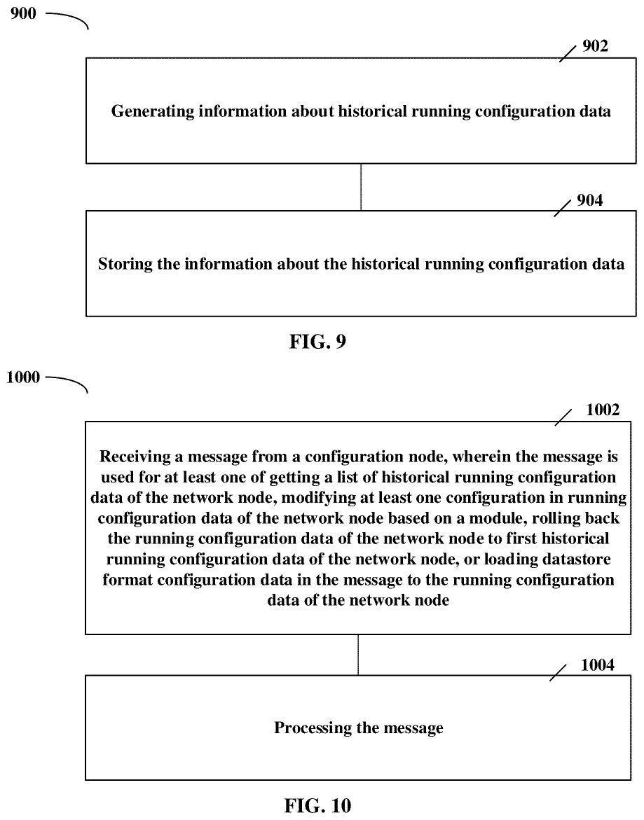

FIG. 10 shows a flowchart of a method according to another embodiment of the present disclosure, which may be performed by an apparatus implemented in or at or as a network node or communicatively coupled to the network node. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the network node may receive a message from a configuration node.

In an embodiment, the message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In an embodiment, the modifying may comprise at least one of creating, undoing, or replacing.

In an embodiment, the message may be used for getting a difference between the running configuration data and second historical running configuration data of the network node from the configuration node.

In an embodiment, the message may be used for getting third historical running configuration data of the network node from the configuration node.

At block 1004, the network node may process the message. For example, if the message is used for getting a list of historical running configuration data of the network node, the network node may send the list of historical running configuration data of the network node to the configuration node. If the message is used for modifying at least one configuration in running configuration data of the network node based on a module, the network node may modify at least one configuration in running configuration data of the network node based on a module. If the message is used for rolling back the running configuration data of the network node to first historical running configuration data of the network node, the network node may roll back the running configuration data of the network node to first historical running configuration data of the network node. If the message is used for loading datastore format configuration data in the message to the running configuration data of the network node, the network node may load datastore format configuration data in the message to the running configuration data of the network node.

In an embodiment, if the network node can't process the message due to various reasons, it may send error information to the configuration node.

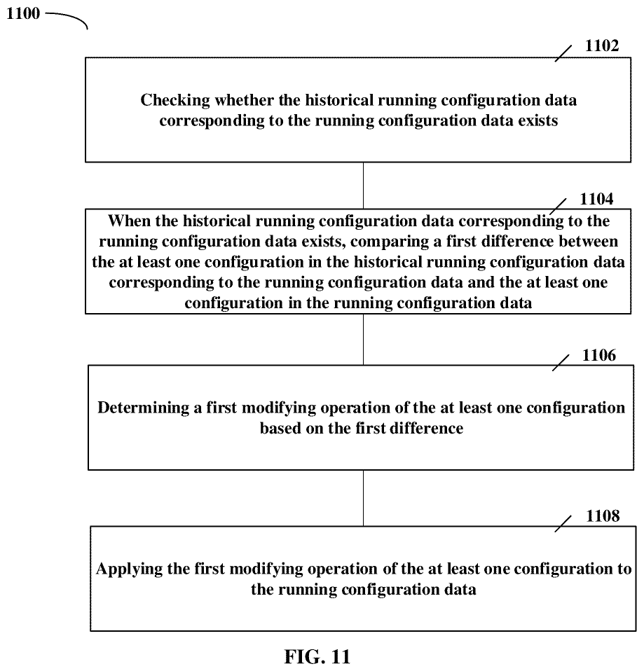

FIG. 11 shows a flowchart of a method according to another embodiment of the present disclosure, which may be performed by an apparatus implemented in or at or as a network node or communicatively coupled to the network node. As such, the apparatus may provide means or modules for accomplishing various parts of the method 1100 as well as means or modules for accomplishing other processes in conjunction with other components. For some parts which have been described in the above embodiments, the description thereof is omitted here for brevity.

In an embodiment, when the message is used for modifying at least one configuration in the running configuration data of the network node based on a module, the message may comprise a name of historical running configuration data corresponding to the running configuration data and information indicating the at least one configuration and the network node may modify at least one configuration in the running configuration data based on the module.

The modifying (e.g., deleting or canceling) configuration unit may be a module. Instead of simply modifying (e.g., deleting or canceling) all the configuration in the running configuration data, it can modify only a module in the running configuration data. The benefit here is huge, because often the user may only want to modify (e.g., delete or cancel) some of the configuration, not all of it. If the user can only modify (e.g., delete or cancel) all of the configurations, then the new configuration is still a lot of work and this is useless work. So this embodiment can implement a way to modify (e.g., delete or cancel) the configuration based on the module.

In an embodiment, the information indicating the at least one configuration comprises a module name of the at least one configuration.

At block 1102, the network node may check whether the historical running configuration data corresponding to the running configuration data exists. For example, the network node may check whether the historical running configuration data corresponding to the running configuration data exists based on the name of historical running configuration data corresponding to the running configuration data.

At block 1104, when the historical running configuration data corresponding to the running configuration data exists, the network node may compare a first difference between the at least one configuration in the historical running configuration data corresponding to the running configuration data and the at least one configuration in the running configuration data. For example, the comparing may be based on the module.

At block 1106, the network node may determine a first modifying operation of the at least one configuration based on the first difference.

For example, if there is no difference between the at least one configuration in the historical running configuration data corresponding to the running configuration data and the at least one configuration in the running configuration data and when the modifying is undoing or creating or replacing, the network node may determine an undoing or creating or replacing operation of the at least one configuration.

For example, if there is a difference between the at least one configuration in the historical running configuration data corresponding to the running configuration data and the at least one configuration in the running configuration data and when the modifying is undoing or replacing, the network node may determine an undoing operation or replacing operation of the at least one configuration (such as module) regardless of the difference. When the modifying is creating, the network node may determine an undoing operation of the at least one configuration and a creating operation of the at least one configuration. Alternatively, the network node may determine a replacing operation of the at least one configuration.

In an embodiment, if there is a difference between the at least one configuration in the historical running configuration data corresponding to the running configuration data and the at least one configuration in the running configuration data, the network node may notify the difference to the configuration node and stop or refuse the modification of the at least one configuration. The configuration node may send a message for getting a list of historical running configuration data of the network node. After knowing the name of historical running configuration data corresponding to the running configuration data, the configuration node may resent the message for modifying at least one configuration in running configuration data of the network node based on a module to the network node.

At block 1108, the network node may apply the first modifying operation of the at least one configuration to the running configuration data.

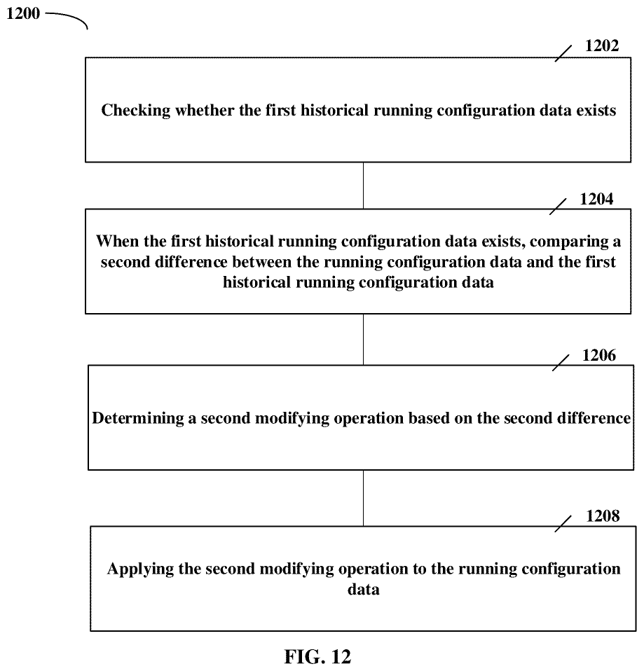

FIG. 12 shows a flowchart of a method according to another embodiment of the present disclosure, which may be performed by an apparatus implemented in or at or as a network node or communicatively coupled to the network node. As such, the apparatus may provide means or modules for accomplishing various parts of the method 1200 as well as means or modules for accomplishing other processes in conjunction with other components. For some parts which have been described in the above embodiments, the description thereof is omitted here for brevity.

In an embodiment, when the message is used for rolling back the running configuration data of the network node to the first historical running configuration data of the network node, the message may comprise a name of the first historical running configuration data and the network node may roll back the running configuration data of the network node to the first historical running configuration data of the network node.

At block 1202, the network node may check whether the first historical running configuration data exists. For example, the network node may check whether the first historical running configuration data exists based on the name of the first historical running configuration data.

At block 1204, when the first historical running configuration data exists, the network node may compare a second difference between the running configuration data and the first historical running configuration data. For example, the comparing may be based on module.

At block 1206, the network node may determine a second modifying operation based on the second difference.

For example, if there is no difference between the running configuration data and the first historical running configuration data, the network node may determine no operation is required to be performed.

For example, if there is a difference between the running configuration data and the first historical running configuration data, the network node may determine an undoing or deleting operation based on the module with the difference and a creating operation based on the module with the difference. Alternatively, the network node may determine a replacing operation based on the module with the difference.

At block 1208, the network node may apply the second modifying operation to the running configuration data.

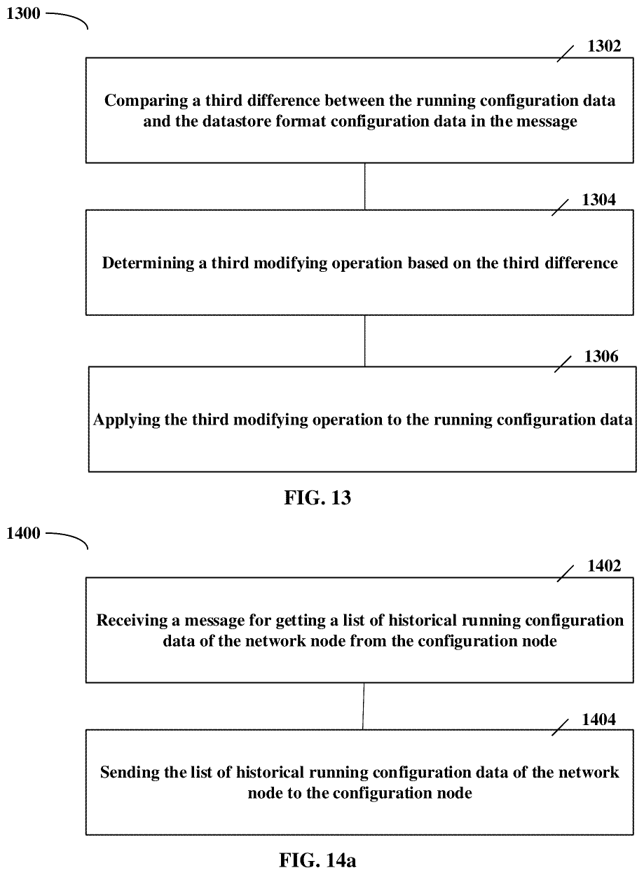

FIG. 13 shows a flowchart of a method according to another embodiment of the present disclosure, which may be performed by an apparatus implemented in or at or as a network node or communicatively coupled to the network node. As such, the apparatus may provide means or modules for accomplishing various parts of the method 1300 as well as means or modules for accomplishing other processes in conjunction with other components. For some parts which have been described in the above embodiments, the description thereof is omitted here for brevity.

In an embodiment, when the message is used for loading datastore format configuration data in the message to the running configuration data of the network node, the network node may load the datastore format configuration data in the message to the running configuration data of the network node.

At block 1302, the network node may compare a third difference between the running configuration data and the datastore format configuration data in the message. For example, the comparing may be based on module.

At block 1304, the network node may determine a third modifying operation based on the third difference.

For example, if there is no difference between the running configuration data and the datastore format configuration data in the message, the network node may determine no operation is required to be performed.

For example, if there is a difference between the running configuration data and the datastore format configuration data in the message, the network node may determine an undoing or deleting operation based on the module with the difference and a creating operation based on the module with the difference. Alternatively, the network node may determine a replacing operation based on the module with the difference.

At block 1306, the network node may apply the third modifying operation to the running configuration data.

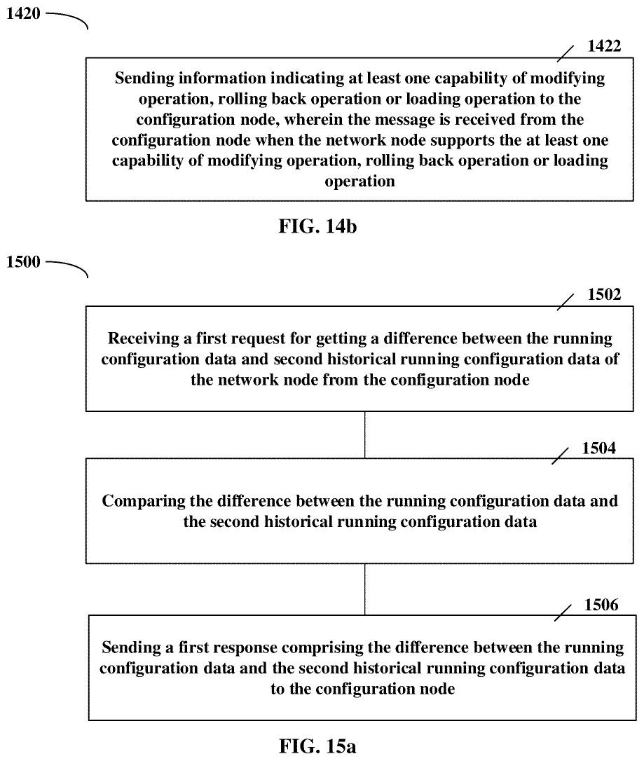

FIG. 14a shows a flowchart of a method according to another embodiment of the present disclosure, which may be performed by an apparatus implemented in or at or as a network node or communicatively coupled to the network node. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the network node may receive a message for getting a list of historical running configuration data of the network node from the configuration node.

At block 1404, the network node may send the list of historical running configuration data of the network node to the configuration node.

In an embodiment, the list of historical running configuration data may comprise at least one of a name of historical running configuration data, a timestamp of a running configuration data change, or an identity of a user who triggers the running configuration data change.

FIG. 14b shows a flowchart of a method according to another embodiment of the present disclosure, which may be performed by an apparatus implemented in or at or as a network node or communicatively coupled to the network node. As such, the apparatus may provide means or modules for accomplishing various parts of the method 1420 as well as means or modules for accomplishing other processes in conjunction with other components. For some parts which have been described in the above embodiments, the description thereof is omitted here for brevity.

At block 1422, the network node may send information indicating at least one capability of modifying operation, rolling back operation or loading operation to the configuration node.

In an embodiment, the message is received from the configuration node when the network node supports the at least one capability of modifying operation, rolling back operation or loading operation.

In an embodiment, the information is sent to the configuration node during a session establishment procedure between the configuration node and the network node.

In an embodiment, the information is comprised in a hello message.

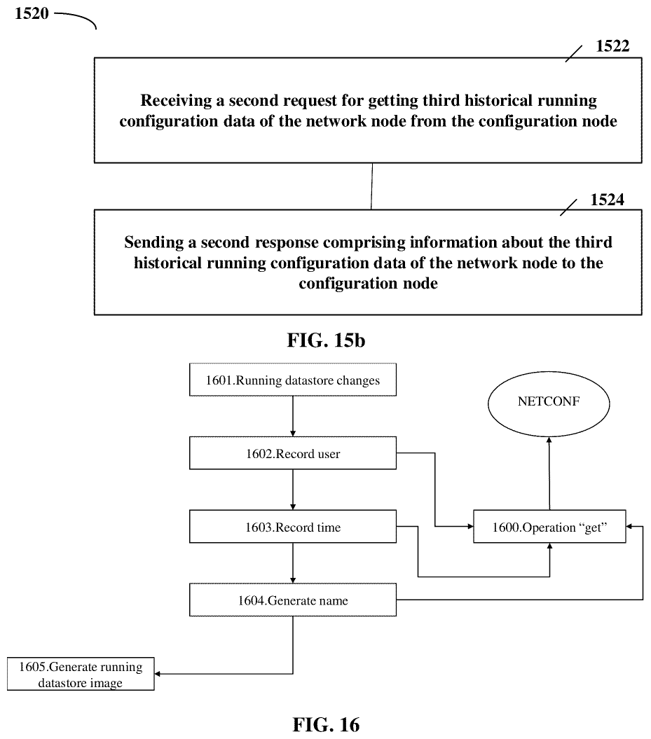

FIG. 15a shows a flowchart of a method according to another embodiment of the present disclosure, which may be performed by an apparatus implemented in or at or as a network node or communicatively coupled to the network node. As such, the apparatus may provide means or modules for accomplishing various parts of the method 1500 as well as means or modules for accomplishing other processes in conjunction with other components. For some parts which have been described in the above embodiments, the description thereof is omitted here for brevity.

At block 1502, the network node may receive a first request for getting a difference between the running configuration data and second historical running configuration data of the network node from the configuration node.

In an embodiment, the first request may comprise a name of the second historical running configuration data.

At block 1504, the network node may compare the difference between the running configuration data and the second historical running configuration data.

At block 1506, the network node may send a first response comprising the difference between the running configuration data and the second historical running configuration data to the configuration node.

FIG. 15b shows a flowchart of a method according to another embodiment of the present disclosure, which may be performed by an apparatus implemented in or at or as a network node or communicatively coupled to the network node. As such, the apparatus may provide means or modules for accomplishing various parts of the method 1520 as well as means or modules for accomplishing other processes in conjunction with other components. For some parts which have been described in the above embodiments, the description thereof is omitted here for brevity.

At block 1522, the network node may receive a second request for getting third historical running configuration data of the network node from the configuration node.

In an embodiment, the second request comprises a name of the third historical running configuration data.

At block 1524, the network node may send a second response comprising information about the third historical running configuration data of the network node to the configuration node.

In an embodiment, the information about the third historical running configuration data comprises at least one of the third historical running configuration data, a name of the third historical running configuration data, a timestamp of a running configuration data change, or an identity of a user who triggers the running configuration data change.

In an embodiment, a message exchanged between the configuration node and the network node is encoded in XML.

In an embodiment, a communication between the configuration node and the network node uses at least one of NETCONF, RESTCONF protocol, or SNMP.

In an embodiment, it defines a new LIST “config-node” and necessary sub-attributes for configuration change every time. This list may be “config false” and automatically generated by “commit” or “copy-config” to running DS. The terms “config false”, “commit” or “copy-config” may be same or similar as/to the corresponding terms as described in IETF RFC 6241 or IETF RFC 8342.

In an embodiment, it defines a new RPC type (command) to get configuration in “config-node”.

In an embodiment, it defines a new RPC type (command) to get configuration difference between historical “config-node” and current running datastore.

In an embodiment, it defines a new RPC type (command) to cancel configuration in historical “config-node”. The cancel unit may be module.

In an embodiment, it defines a new RPC type (command) to restore configuration from one of “config-node”.

In an embodiment, it defines a new RPC type (command) to restore DS format configuration from a NETCONF session interface.

In an embodiment, it defines a new LIST and RPCs in YANG to reach the result that NETCONF-YANG can support historical configuration recording, getting, and restoring.

In an embodiment, NETCONF is pure model based, so the agreed model should or may be defined first before any interactive action between the network node such as NE and the configuration node such as NMS.

In an embodiment, following NETCONF standard, the aligned model should or may be installed on both the network node and the configuration node firstly, and then the network node and the configuration node could know the interactive message format.

In an embodiment, it illustrates an example of the “ericsson-config-record” module tree diagram as following.

```
module: ericsson-config-record
  +−−ro config-record
      +−−ro config-record-entry* [name]
```

| | |
|---|---|
| +−−ro name | string |
| +−−ro timestamp? | date-timestamp |
| +−−ro user? | string |

```
  rpcs:
    +−−−x get-config-record
    | +−−−w input
```

| \| \| | +−−−w target | |
|---|---|---|
| \| \| | +−−−w name | string |

| +−−ro output

| | | |
|---|---|---|
| \| | +−−ro data? | <anyxml> |

```
    +−−−x get-config-record-diff
    | +−−−w input
```

| \| \| | +−−−w target | |
|---|---|---|
| \| \| | +−−−w name | string |

| +−−ro output

| | | |
|---|---|---|
| \| | +−−ro data? | <anyxml> |

```
    +−−−x undo-config
    | +−−−w input
```

| \| | +−−−w target | |
|---|---|---|
| \| | +−−−w name | string |
| \| | +−−−w module-name | string |

```
    +−−−x rollback-config-record
    | +−−−w input
```

| \| | +−−−w target | |
|---|---|---|
| \| | +−−−w name | string |

```
    +−−−x restore-config
        +−−−w input
```

| | |
|---|---|
| +−−−w config | <anyxml> |

LIST “config-record”: This is a list of historical running DS changes with “leaf name” as the key. The network node should or may automatically generate such a node to record the change in the running configuration. This node should or may contain the configuration change timestamp and user information, as well as a full image of the changed running DS. This running DS image can be used to get the configuration at this point in time and for configuration recovery.
LEAF “name”: The name of the configuration change record node.
LEAF “timestamp”: The timestamp of the configuration change.
LEAF “user”: the user who triggers this configuration change.
RPC “get-config-record”: Get configuration in DS format which records in ‘config-record’.
RPC input: The name of the configuration saved in the LIST “config-record”.
RPC “get-config-record-diff”: Get configuration difference between historical configuration record in config-record and current running datastore.
RPC input: The name of the configuration saved in the LIST “config-record”.
RPC “undo-config”: Undo configuration which records in historical ‘config-record’ of the running datastore. The cancel configuration unit may be module. Instead of simply cancelling all configurations in the historical ‘config-record’, it can unconfigure only one module in all the configurations of the history node. If the user wants to cancel all configurations in this history node, it can be done by using following RPC “rollback-config-record”.

The benefit here is huge, because often the user may only want to delete or cancel some of the configuration, not all of it. If the user can only cancel all of the configuration, then the new configuration is still a lot of work and this is useless work. So here the embodiments implement a way to cancel the historical configuration based on the module.
RPC input: The name of the configuration saved in the LIST “config-record”.
RPC input: The module name of the configuration needs to undo.
RPC “rollback-config-record”: Roll back configuration of the running DS to the configuration of a node stored in the LIST “config-record”.
RPC input: The name of the configuration saved in the LIST “config-record”.
RPC “restore-config”: The <restore-config> operation loads all configuration to the running datastore. The input configuration should or may be in DS format.
RPC input: Inline Config content.

In an embodiment, an example of new YANG Module may be as following.

```
<CODE BEGINS> file “ ericsson-config-record.yang”
    module ericsson-config-record {
      yang-version 1.1;
      namespace “urn:ietf:params:xml:ns:yang:ericsson-config-recordor”;
      prefix ericconfigrec;
      organization
        “Ericsson AB”;
      contact
            “Web: <http://www.ericsson.com>”;
      description
        “This module is defined to record running
          datastore change, and action to restore the configuration in the datastore.
          Copyright (c) 2018 Ericsson AB.
          All rights reserved”;
      revision 2022-09-15 {
        description
            “Initial revision.”;
      }
      typedef date-timestamp {
        type string {
            pattern ‘\d{4}−\d{2}−\d{2}T\d{2}:\d{2}:\d{2}(\.\d+)?’
                        + ‘(Z|[\+\−]\d{2}:\d{2})’;
        }
        description
            “A date and time, expressed in the format described in RFC3339.
              That is to say: YYYY-MM-DDTHH:MM:SSZ+−hh:mm”;
        reference
            “RFC3339 - Date and Time on the Internet: Timestamps”;
      }
      container config-record {
        config false;
        description
            “Running datastore change history”;
        list config-record-entry {
            key “name”;
            config false;
            description
                “After each running datastore change - which represents a change
                  in the configuration running on the NE - the NE automatically
                  generates such a node to record the change in the running configuration.
                  This node should or may contain the configuration change timestamp
                  and user information, as well as a full image of the changed running datastore.
                  This running datastore image can be used to get the configuration
                  at this point in time and for configuration recovery”;
            leaf name {
                type string {
                    length “1..256”;
                }
                config false;
                description
                    “The name of the configuration change this time.”;
            }
            leaf timestamp {
                type date-timestamp;
                config false;
                description
                    “The timestamp of the configuration change.”;
            }
            leaf user {
                type string {
                    length “1..256”;
                }
                config false;
                description
                    “The user who triggers this configuration change.”;
            }
        }
      }
      rpc get-config-record {
        description
            “Get configuration in datastore format which record in ‘config-record-entry’.”;
        input {
            container target {
                description
                    “Target configuration to be gotten.”;
                leaf name {
                    mandatory true;
                    type string {
                        length “1..256”;
                    }
                    description
                        “The name of the configuration saved in LIST config-record-entry.”;
                }
            }
        }
        output {
            anyxml data {
                description
                    “Copy of the configuration in datastore format that matched
                      the filter criteria (if any). An empty data container
                      indicates that the request did not produce any results.”;
            }
        }
      }
      rpc get-config-record-diff {
        description
            “Get configuration difference with current running datastore in datastore format which
    record in ‘config-record-entry’.”;
        input {
            container target {
                description
                    “Target configuration to be gotten.”;
                leaf name {
                    mandatory true;
                    type string {
                        length “1..256”;
                    }
                    description
                        “The name of the configuration saved in LIST config-record-entry.”;
                }
            }
        }
        output {
            anyxml data {
                description
                    “Copy of the configuration in datastore format that matched
                      the filter criteria (if any). An empty data container
                      indicates that the request did not produce any results.”;
            }
        }
      }
      rpc undo-config {
        description
            “Undo configuration of the running datastore.”;
        input {
            container target {
                description
                    “Target configuration to be canceled in running datastore, the unit is module.”;
                leaf name {
                    mandatory true;
                    type string {
                        length “1..256”;
                    }
                    description
                        “The name of the configuration saved in LIST config-record-entry.”;
                }
                leaf module-name {
                    mandatory true;
                    type string {
                        length “1..256”;
                    }
                    description
                        “The configuration of this module need to be cancled”;
                }
            }
        }
      }
      rpc rollback-config-record {
        description
            “Roll back configuration of the running datastore to
              the configuration of a node stored in LIST config-record-entry.
              The input is the name of the node stored in ‘config-record-entry’.”;
        input {
            container target {
                description
                    “Target configuration to be gotten.”;
                leaf name {
                    mandatory true;
                    type string {
                        length “1..256”;
                    }
                    description
                        “The name of the configuration saved in LIST config-record-entry.”;
                }
            }
        }
      }
      rpc restore-config {
        description
            “The <restore-config> operation loads all configuration to the running datastore.
              The input configuration should or may be in datastore format.”;
        input {
            anyxml config {
                mandatory true;
                description
                    “Inline Config content.”;
            }
        }
      }
    }
  <CODE ENDS>
```

FIG. 16 shows a flowchart of storing running DS change image according to another embodiment of the present disclosure.

At block 1600. When a user runs a <get> operation in NETCONF, the NE needs to store the above data in the LIST “config-record” and return it to the user.

At block 1601. Running datastore changes.

At blocks 1602, 1603, 1604 and 1605. The NE needs to automatically record every time the Running DS configuration changes. The NE may assign a human readable name for this configuration change. The NE may record the time when the configuration change occurred. The NE may record the user who modified the configuration. The NE may generate and save the full running DS image.

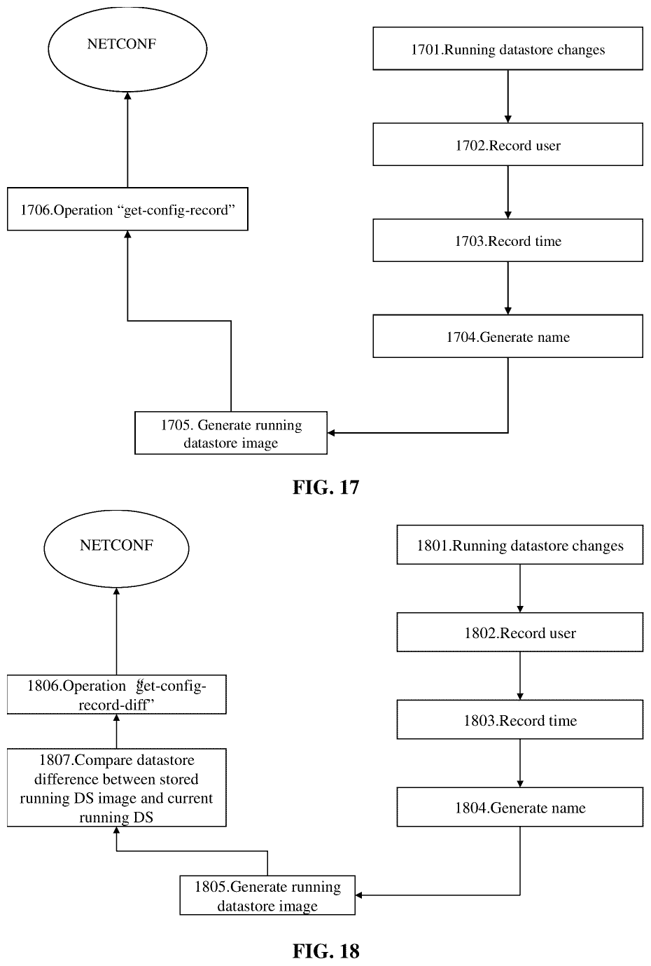

FIG. 17 shows a flowchart of getting stored running DS image according to another embodiment of the present disclosure.

At block 1701. Running datastore changes.

At blocks 1702, 1703, 1704 and 1705. The NE needs to automatically record every time the Running DS configuration changes. The NE may assign a human readable name for this configuration change. The NE may record the time when the configuration change occurred. The NE may record the user who modified the configuration. The NE may generate and save the full running DS image.

At block 1706. The user runs a “get-config-record” operation in NETCONF. It is very likely that the user will want to view the configuration information of previous and proceed to the next step (such as configuration rollback) after confirm it is the desired configuration, so here is how to achieve this through RPC (command) “get-config-record”. Note that the format of the return value is “anyxml”, which is identical to the format of the “get-config” already defined by the standard, for example:

```
<interfaces xmlns=“urn:ietf:params:xml:ns:yang:ietf-interfaces”>
  <interface>
    <name>mgmt@local</name>
    <type xmlns:ianaift=“urn:ietf:params:xml:ns:yang:iana-if-type”>ianaift:ipForward</type>
    <l3-interface xmlns=“urn:rdns:com:ericsson:oammodel:ericsson-interfaces-ext-router6000”>
      <context>local</context>
      <ip>
        <address>
          <addr-primary-conf>
            <addr>10.170.115.215/24</addr>
          </addr-primary-conf>
        </address>
      </ip>
    </l3-interface>
  </interface>
</interfaces>
```

FIG. 18 shows a flowchart of getting a difference between stored running DS image and current running DS according to another embodiment of the present disclosure.

At block 1801. Running datastore changes.

At blocks 1802, 1803, 1804 and 1805. The NE needs to automatically record every time the Running DS configuration changes. The NE may assign a human readable name for this configuration change. The NE may record the time when the configuration change occurred. The NE may record the user who modified the configuration. The NE may generate and save the full running DS image.

At block 1806. The user runs a “get-config-record-diff” operation in NETCONF. It is also likely that the user will want to view the configuration difference between previous and current, so here is how to achieve this through RPC (command) “get-config-record-diff”. Note that the format of the return value is “anyxml”, for example:

```
<?xml version=“1.0” encoding=“UTF-8”?>
<rpc-reply xmlns=“urn:ietf:params:xml:ns:netconf:base:1.0” message-id=“7”>
  <data xmlns:nc=“urn:ietf:params:xml:ns:netconf:base:1.0”>
    <contexts xmlns=“urn:rdns:com:ericsson:oammodel:ericsson-contexts-router6000”
sr:operation=“none”>
      <context xmlns=“urn:rdns:com:ericsson:oammodel:ericsson-context-router6000”>
        <context-name>local</context-name>
        <ntp-mode xmlns=“urn:rdns:com:ericsson:oammodel:ericsson-ntp-router6000”
nc:operation=“create”>
          <peer>
            <peer-choice>7.7.7.7</peer-choice>
          </peer>
        </ntp-mode>
      </context>
    </contexts>
  </data>
</rpc-reply>
```

At block 1807. The NE may compare datastore difference between stored running DS image and current running DS. The NE may provide the datastore difference to the user.

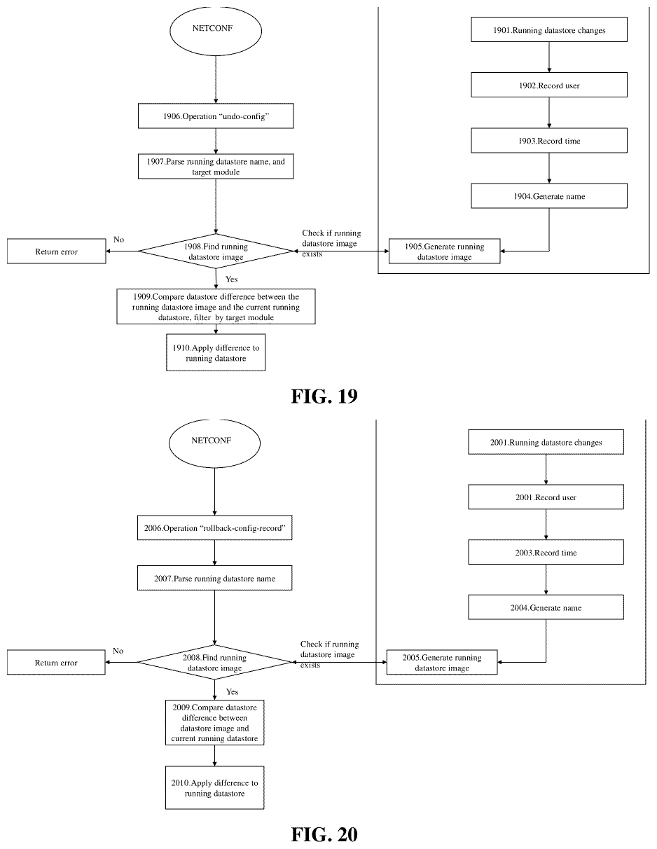

FIG. 19 shows a flowchart of unconfiguring a module of configuration, which was configured in the history and stored in LIST config-record-entry, in the current running DS according to another embodiment of the present disclosure.

At block 1901. Running datastore changes.

At blocks 1902, 1903, 1904 and 1905. The NE needs to automatically record every time the Running DS configuration changes. The NE may assign a human readable name for this configuration change. The NE may record the time when the configuration change occurred. The NE may record the user who modified the configuration. The NE may generate and save the full running DS image.

At block 1906. The user runs a “undo-config” operation in NETCONF.

At block 1907. NE receives the RPC (command) “undo-config” and parses running datastore name and the target module.

At block 1908. The NE finds the running DS image by the input parameter “name” of RPC “undo-config”. The NE finds the target module by the input parameter “module-name” of RPC “undo-config”. If the running datastore image does not exist, the NE may return error information to the user.

At block 1909. The NE compares datastore difference between the running datastore image and the current running datastore, filter by the target module. For example, the NE compares the running DS image and current running DS based YANG models, only generate the difference and corresponding operation (create, delete, replace, etc.) of target module in a data structure.

At block 1910. The NE may apply the difference to running DS.

FIG. 20 shows a flowchart of rolling back a configuration of the running DS to the configuration of a node stored in LIST config-record-entry according to another embodiment of the present disclosure.

A problem that the embodiment aims to solve is that the NE cannot easily go back to its previous configuration state through NETCONF. The RPC (command) “rollback-config-record” can solve this problem.

At block 2001. Running datastore changes.

At blocks 2002, 2003, 2004 and 2005. The NE needs to automatically record every time the Running DS configuration changes. The NE may assign a human readable name for this configuration change. The NE may record the time when the configuration change occurred. The NE may record the user who modified the configuration. The NE may generate and save the full running DS image.

At block 2006. The user runs a “rollback-config-record” operation in NETCONF.

At block 2007. NE receives the RPC (command) “rollback-config-record”.

At block 2008. The NE finds the running DS image by the input parameter “name” of “rollback-config-record”. If the running datastore image does not exist, the NE may return error information to the user.

At block 2009. The NE compares datastore difference between the datastore image and the current running datastore. For example, the NE compares the running DS image and current running DS based YANG models, generate the difference and corresponding operation (create, delete, replace, etc.) in a data structure.

At block 2010. The NE may apply the difference to running DS.

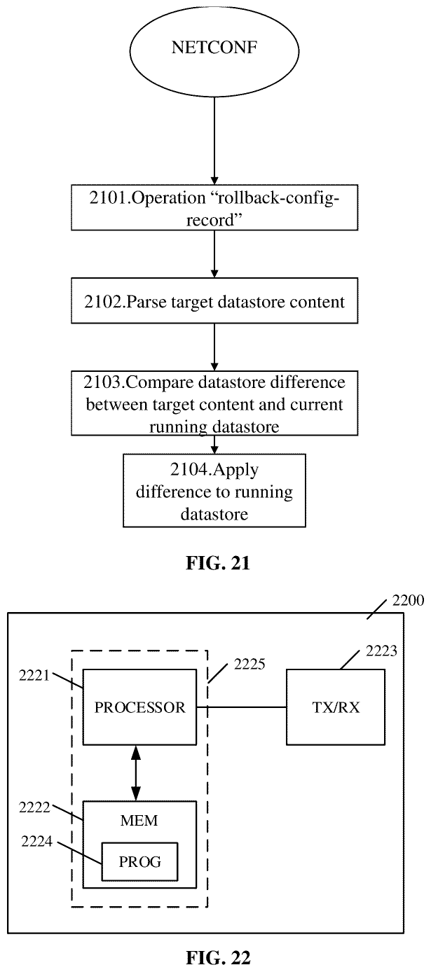

FIG. 21 shows a flowchart of restoring configuration of the running DS according to another embodiment of the present disclosure.

A problem that the embodiment aims to solve is that the NE cannot easily restore a DS format configuration. In most cases, it needs to manually compare the target configuration with the current configuration, and then deliver the configuration through the <edit-config> command in create, delete, or replace operation. The RPC (command) “restore-config” can solve this problem.

At block 2101. The user runs a “restore-config” operation in NETCONF.

At block 2102. The NE receives the RPC (command) “restore-config” and parses target datastore content.

At block 2103. The NE finds the target DS format configuration by the input parameter “config” of “rollback-config-record”. The NE compares datastore difference between the target content and current running datastore. For example, the NE compares the target DS and current running DS based YANG models, and generates the difference and corresponding operation (create, delete, replace, etc.) in a data structure.

At block 2104. The NE may apply the difference to running DS.

Embodiments herein afford many advantages, of which a non-exhaustive list of examples follows. In some embodiments herein, the proposed solution can enable the configuration process (such as NETCONF-YANG configuration process) to be more convenient. In some embodiments herein, the proposed solution can reduce the workload of users and/or configuration errors. In some embodiments herein, the proposed solution can provide a convenient way to record and/or view and/or roll back historical configuration (such as NETCONF-YANG's historical configuration) for the benefit of users. In some embodiments herein, the proposed solution can undo historical configuration in module unit. The embodiments herein are not limited to the features and advantages mentioned above. A person skilled in the art will recognize additional features and advantages upon reading the following detailed description.

FIG. 22 is a block diagram showing an apparatus suitable for practicing some embodiments of the disclosure. For example, the network node or the configuration node described above may be implemented as or through the apparatus 2200.

The apparatus 2200 comprises at least one processor 2221, such as a digital processor (DP), and at least one memory (MEM) 2222 coupled to the processor 2221. The apparatus 2220 may further comprise a transmitter TX and receiver RX 2223 coupled to the processor 2221. The MEM 2222 stores a program (PROG) 2224. The PROG 2224 may include instructions that, when executed on the associated processor 2221, enable the apparatus 2220 to operate in accordance with the embodiments of the present disclosure. A combination of the at least one processor 2221 and the at least one MEM 2222 may form processing means 2221 adapted to implement various embodiments of the present disclosure.

Various embodiments of the present disclosure may be implemented by computer program executable by one or more of the processor 2221, software, firmware, hardware or in a combination thereof.

The MEM 2222 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2221 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the configuration node, the memory 2222 contains instructions executable by the processor 2221, whereby the configuration node operates according to any step of the methods related to the configuration node as described above.

In an embodiment where the apparatus is implemented as or at the network node, the memory 2222 contains instructions executable by the processor 2221, whereby the network node operates according to any step of the methods related to the network node as described above.

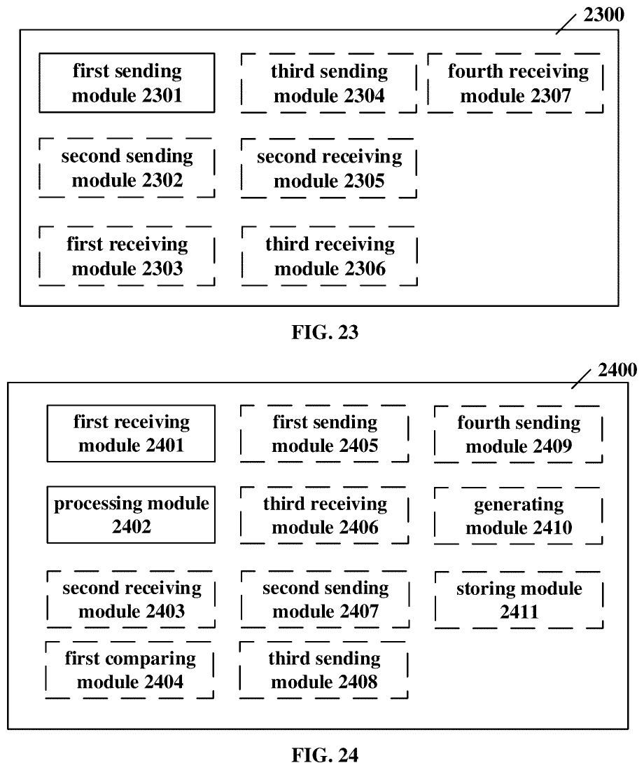

FIG. 23 is a block diagram showing a configuration node according to an embodiment of the disclosure. As shown, the configuration node 2300 comprises a first sending module 2301 configured to send a message to a network node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node.

In an embodiment, the configuration node 2300 further comprises a second sending module 2302 configured to send a first request for getting a difference between the running configuration data and second historical running configuration data of the network node to the network node.

In an embodiment, the configuration node 2300 further comprises a first receiving module 2303 configured to receive a first response comprising the difference between the running configuration data and the second historical running configuration data of the network node from the network node.

In an embodiment, the configuration node 2300 further comprises a third sending module 2304 configured to send a second request for getting third historical running configuration data of the network node to the network node.

In an embodiment, the configuration node 2300 further comprises a second receiving module 2305 configured to receive a second response comprising information about the third historical running configuration data of the network node from the network node.

In an embodiment, the configuration node 2300 further comprises a third receiving module 2306 configured to receive the list of historical running configuration data of the network node from the network node.

In an embodiment, the configuration node 2300 further comprises a fourth receiving module 2307 configured to receive information indicating at least one capability of modifying operation, rolling back operation or loading operation from the network node. The message may be sent to the network node when the network node supports the at least one capability of modifying operation, rolling back operation or loading operation.

FIG. 24 is a block diagram showing a network node according to an embodiment of the disclosure. As shown, the network node 2400 comprises a first receiving module 2401 configured to receive a message from a configuration node. The message may be used for at least one of getting a list of historical running configuration data of the network node, modifying at least one configuration in running configuration data of the network node based on a module, rolling back the running configuration data of the network node to first historical running configuration data of the network node, or loading datastore format configuration data in the message to the running configuration data of the network node. The network node 2400 further comprises a processing module 2402 configured to process the message.

In an embodiment, the network node 2400 further comprises a second receiving module 2403 configured to receive a first request for getting a difference between the running configuration data and second historical running configuration data of the network node from the configuration node.

In an embodiment, the network node 2400 further comprises a first comparing module 2404 configured to compare the difference between the running configuration data and the second historical running configuration data.

In an embodiment, the network node 2400 further comprises a first sending module 2405 configured to send a first response comprising the difference between the running configuration data and the second historical running configuration data to the configuration node.

In an embodiment, the network node 2400 further comprises a third receiving module 2406 configured to receive a second request for getting third historical running configuration data of the network node from the configuration node.

In an embodiment, the network node 2400 further comprises a second sending module 2407 configured to send a second response comprising information about the third historical running configuration data of the network node to the configuration node.

In an embodiment, the network node 2400 further comprises a third sending module 2408 configured to send the list of historical running configuration data of the network node to the configuration node.

In an embodiment, the network node 2400 further comprises a fourth sending module 2409 configured to send information indicating at least one capability of modifying operation, rolling back operation or loading operation to the configuration node. The message may be received from the configuration node when the network node supports the at least one capability of modifying operation, rolling back operation or loading operation.

In an embodiment, the network node 2400 further comprises a generating module 2410 configured to generate information about historical running configuration data.

In an embodiment, the network node 2400 further comprises a storing module 2411 configured to store the information about the historical running configuration data.

Further, the exemplary overall commutation system including the terminal device and the network node will be introduced as below.

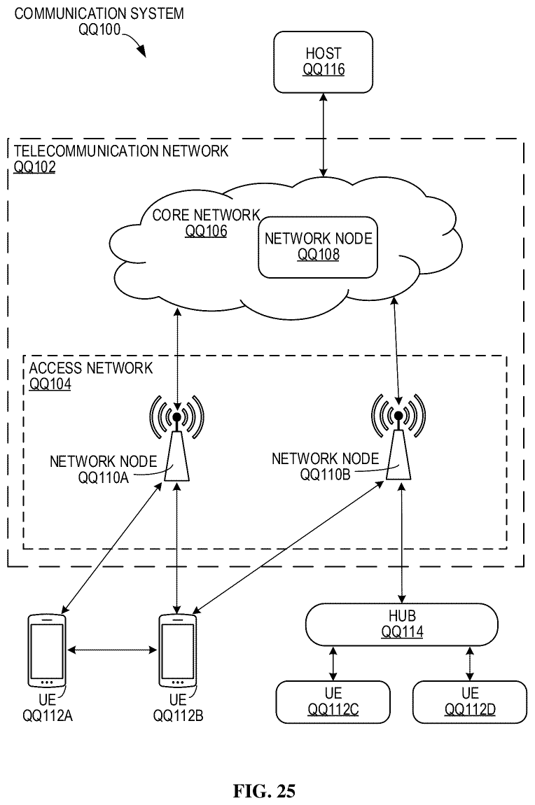

FIG. 25 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 25 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

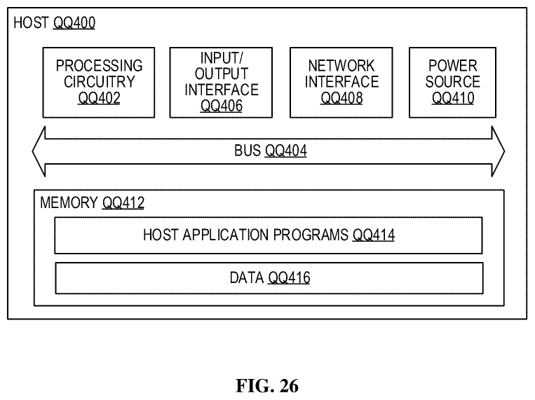

FIG. 26 is a block diagram of a host QQ400, which may be an embodiment of the host QQ116 of FIG. 25, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

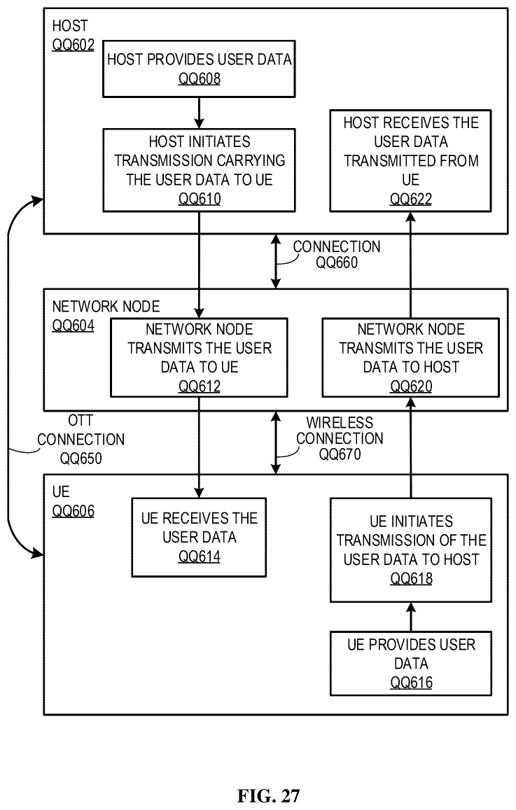

FIG. 27 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 25), network node (such as network node QQ110a of FIG. 25), and host (such as host QQ116 of FIG. 25 and/or host QQ400 of FIG. 26) discussed in the preceding paragraphs will now be described with reference to FIG. 27.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 25) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, the proposed solution can enable the configuration process (such as NETCONF-YANG configuration process) to be more convenient. In some embodiments herein, the proposed solution can reduce the workload of users and/or configuration errors. In some embodiments herein, the proposed solution can provide a convenient way to record and/or view and/or roll back historical configuration (such as NETCONF-YANG's historical configuration) for the benefit of users. In some embodiments herein, the proposed solution can undo historical configuration in module unit.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.
Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit the user data from the host to the UE:
Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.
Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE:
Embodiment 4. The method of the previous embodiment, further comprising, at the network node, transmitting the user data provided by the host for the UE.
Embodiment 5. The method of any of the previous 2 embodiments, wherein the user data is provided at the host by executing a host application that interacts with a client application executing on the UE, the client application being associated with the host application.
Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit the user data from the host to the UE:
Embodiment 7. The communication system of the previous embodiment, further comprising:
the network node; and/or
the user equipment.
Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.
Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive the user data from the UE for the host:
Embodiment 10. The host of the previous 2 embodiments, wherein:
the processing circuitry of the host is configured to execute a host application, thereby providing the user data; and
the host application is configured to interact with a client application executing on the UE, the client application being associated with the host application.
Embodiment 11. The host of they of the previous 2 embodiments, wherein the initiating receipt of the user data comprises requesting the user data.
Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host:
Embodiment 13. The method of the previous embodiment, further comprising at the network node, transmitting the received user data to the host.
Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the UE as described above to receive the user data from the host:
Embodiment 15. The host of the previous embodiment, wherein the cellular network further includes a network node configured to communicate with the UE to transmit the user data to the UE from the host.
Embodiment 16. The host of the previous 2 embodiments, wherein:
the processing circuitry of the host is configured to execute a host application, thereby providing the user data; and
the host application is configured to interact with a client application executing on the UE, the client application being associated with the host application.
Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the UE as described above to receive the user data from the host:
Embodiment 18. The method of the previous embodiment, further comprising:
at the host, executing a host application associated with a client application executing on the UE to receive the user data from the UE.
Embodiment 19. The method of the previous embodiment, further comprising:
at the host, transmitting input data to the client application executing on the UE, the input data being provided by executing the host application,
wherein the user data is provided by the client application in response to the input data from the host application.
Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the UE as described above to transmit the user data to the host:
Embodiment 21. The host of the previous embodiment, wherein the cellular network further includes a network node configured to communicate with the UE to transmit the user data from the UE to the host.
Embodiment 22. The host of the previous 2 embodiments, wherein:
the processing circuitry of the host is configured to execute a host application, thereby providing the user data; and
the host application is configured to interact with a client application executing on the UE, the client application being associated with the host application.
Embodiment 23. A method implemented by a host configured to operate in a communication system that further includes a network node and a user equipment (UE), the method comprising:
at the host, receiving user data transmitted to the host via the network node by the UE, wherein the UE performs the operations related to the UE as described above to transmit the user data to the host:
Embodiment 24. The method of the previous embodiment, further comprising:
at the host, executing a host application associated with a client application executing on the UE to receive the user data from the UE.
Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the network node or the configuration node may not need a fixed processor or memory, any computing resource and storage resource may be arranged from the network node or the configuration node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a configuration node, comprising: sending a message to a network node,
wherein the message is used for at least one of:
getting a list of historical running configuration data of the network node,
modifying at least one configuration in running configuration data of the network node based on a module,
rolling back the running configuration data of the network node to first historical running configuration data of the network node, or
loading datastore format configuration data in the message to the running configuration data of the network node.

2. The method according to claim 1, further comprising:
sending a first request for getting a difference between the running configuration data and second historical running configuration data of the network node to the network node; and
receiving a first response comprising the difference between the running configuration data and the second historical running configuration data of the network node from the network node.

3. The method according to claim 2, wherein the first request comprises a name of the second historical running configuration data.

4. The method according to claim 1, further comprising:
sending a second request for getting third historical running configuration data of the network node to the network node; and
receiving a second response comprising information about the third historical running configuration data of the network node from the network node.

5. The method according to claim 4, wherein the second request comprises a name of the third historical running configuration data.

6. The method according to claim 4, wherein the information about the third historical running configuration data comprises at least one of:
the third historical running configuration data,
a name of the third historical running configuration data,
a timestamp of a running configuration data change, or
an identity of a user who triggers the running configuration data change.

7. The method according to claim 1, wherein when the message is used for modifying at least one configuration in the running configuration data of the network node based on a module, the message comprises a name of historical running configuration data corresponding to the running configuration data and information indicating the at least one configuration;
wherein when the message is used for rolling back the running configuration data of the network node to the first historical running configuration data of the network node, the message comprises a name of the first historical running configuration data; or
wherein when the message is used for getting a list of historical running configuration data of the network node, the method further comprises:
receiving the list of historical running configuration data of the network node from the network node.

8-10. (canceled)

11. The method according to claim 1, wherein the list of historical running configuration data comprises at least one of:
a name of historical running configuration data,
a timestamp of a running configuration data change, or
an identity of a user who triggers the running configuration data change.

12. The method according to claim 1, further comprising:
receiving information indicating at least one capability of modifying operation, rolling back operation or loading operation from the network node,
wherein the message is sent to the network node when the network node supports the at least one capability of modifying operation, rolling back operation or loading operation.

13. The method according to claim 12, wherein the information is received from the network node during a session establishment procedure between the configuration node and the network node.

14-17. (canceled)

18. A method performed by a network node, comprising:
receiving a message from a configuration node; and
processing the message,
wherein the message is used for at least one of:
getting a list of historical running configuration data of the network node,
modifying at least one configuration in running configuration data of the network node based on a module,
rolling back the running configuration data of the network node to first historical running configuration data of the network node, or
loading datastore format configuration data in the message to the running configuration data of the network node.

19. The method according to claim 18, further comprising:
receiving a first request for getting a difference between the running configuration data and second historical running configuration data of the network node from the configuration node;
comparing the difference between the running configuration data and the second historical running configuration data; and
sending a first response comprising the difference between the running configuration data and the second historical running configuration data to the configuration node;
wherein the first request comprises a name of the second historical running configuration data.

20. (canceled)

21. The method according to claim 18, further comprising:
receiving a second request for getting third historical running configuration data of the network node from the configuration node; and
sending a second response comprising information about the third historical running configuration data of the network node to the configuration node;
wherein the second request comprises a name of the third historical running configuration data; and/or
wherein the information about the third historical running configuration data comprises at least one of:
the third historical running configuration data,
a name of the third historical running configuration data,
a timestamp of a running configuration data change, or
an identity of a user who triggers the running configuration data change.

22-23. (canceled)

24. The method according to claim 18, wherein when the message is used for modifying at least one configuration in the running configuration data of the network node based on a module,
the message comprises a name of historical running configuration data corresponding to the running configuration data and information indicating the at least one configuration, and
processing the message comprises modifying at least one configuration in the running configuration data based on a module;
wherein when the message is used for rolling back the running configuration data of the network node to the first historical running configuration data of the network node, the message comprises a name of the first historical running configuration data, and processing the message comprises rolling back the running configuration data of the network node to the first historical running configuration data of the network node;
wherein when the message is used for loading datastore format configuration data in the message to the running configuration data of the network node, processing the message comprises loading the datastore format configuration data in the message to the running configuration data of the network node; or
wherein when the message is used for getting a list of historical running configuration data of the network node, the method further comprising:
sending the list of historical running configuration data of the network node to the configuration node.

25-31. (canceled)

32. The method according to claim 18, wherein the list of historical running configuration data comprises at least one of:
a name of historical running configuration data,
a timestamp of a running configuration data change, or
an identity of a user who triggers the running configuration data change.

33. The method according to claim 18, further comprising:
sending information indicating at least one capability of modifying operation, rolling back operation or loading operation to the configuration node,
wherein the message is received from the configuration node when the network node supports the at least one capability of modifying operation, rolling back operation or loading operation.

34. The method according to claim 33, wherein the information is sent to the configuration node during a session establishment procedure between the configuration node and the network node.

35. (canceled)

36. The method according to claim 18, further comprising:
generating information about historical running configuration data; and
storing the information about the historical running configuration data.

37. The method according to claim 36, wherein the information about the historical running configuration data comprises at least one of:
the historical running configuration data,
a name of the historical running configuration data,
a timestamp of a running configuration data change, or
an identity of a user who triggers the running configuration data change.

38-42. (canceled)

43. A network node, comprising:
a processor; and
a memory coupled to the processor, said memory containing instructions executable by said processor, whereby said network node is operative to:
receive a message from a configuration node; and
process the message,
wherein the message is used for at least one of:
getting a list of historical running configuration data of the network node,
modifying at least one configuration in running configuration data of the network node based on a module,
rolling back the running configuration data of the network node to first historical running configuration data of the network node, or
loading datastore format configuration data in the message to the running configuration data of the network node.

44-46. (canceled)
